(19) United States
(12) Patent Application Publication
(10) Pub. No.: US 2017/0172715 A1
(43) Pub. Date: Jun. 22, 2017

(54) FLOSS DISPENSERS

(71) Applicant: Flosstime Inc., Palo Alto, CA (US)

(72) Inventors: Duc DUONG, Mountain View, CA (US); Gregorio FARIA, Palo Alto, CA (US); Michael EVANS, Palo Alto, CA (US)

(21) Appl. No.: 15/374,688

(22) Filed: Dec. 9, 2016

Related U.S. Application Data
(63) Continuation-in-part of application No. 14/835,498, filed on Aug. 25, 2015.
(60) Provisional application No. 62/388,745, filed on Feb. 8, 2016.
(60) Provisional application No. 62/493,805, filed on Jul. 18, 2016.
(60) Provisional application No. 62/070,388, filed on Aug. 25, 2014.
(60) Provisional application No. 62/124,302, filed on Dec. 15, 2014.

(51) Int. Cl. A61C 15/04

(52) U.S. Cl. CPC A61C 15/043

(57) ABSTRACT

Floss cartridges are described. In one embodiment, a floss cartridge may comprise a cartridge chassis configured to hold floss, and a pair of rollers coupled to the cartridge chassis. The rollers may contact each other at a pinch point. The rollers may be configured to feed the floss through the pinch point at a feed angle. Methods of using a floss dispenser are also described. In one embodiment, the method may comprise coupling a floss cartridge to a housing. The floss cartridge may be configured to hold floss. The floss cartridge may have a pair of rollers contacting each other at a pinch point. The method may also comprise driving a pair of rollers to feed the floss from the pinch point at a feed angle.

### CROSS-REFERENCE TO RELATED APPLICATIONS

This application claims the benefit of U.S. provisional application Nos. 62/388,745, filed Feb. 8, 2016, and 62/493,805, filed Jul. 18, 2016. This application is also a continuation-in-part of U.S. patent application Ser. No. 14/835,498, filed Aug. 25, 2015, which claims the benefit of U.S. provisional application Nos. 62/070,388, filed Aug. 25, 2014, and 62/124,302, filed Dec. 15, 2014. The applications listed above are hereby incorporated by reference in their entireties.

### BACKGROUND

Flossing is important to oral hygiene. However, flossing may be neglected, for a variety of reasons.

People may not floss as often as they need to. People may not be flossing because they do not see the floss. People may not be flossing because they feel it is too much trouble to get the floss. People may not be flossing because they feel flossing is boring or troublesome.

People may not floss for as long as they need to. People may be flossing for a shorter time than they believe they are flossing.

What is needed is a device which will facilitate flossing.

### SUMMARY

Floss cartridges are described. In one embodiment, a floss cartridge may comprise a cartridge chassis configured to hold floss, and a pair of rollers coupled to the cartridge chassis. The rollers may contact each other at a pinch point. The rollers may be configured to feed the floss through the pinch point at a feed angle.

Methods of using a floss dispenser are also described. In one embodiment, the method may comprise coupling a floss cartridge to a housing. The floss cartridge may be configured to hold floss. The floss cartridge may have a pair of rollers contacting each other at a pinch point. The method may also comprise driving a pair of rollers to feed the floss from the pinch point at a feed angle.

### BRIEF DESCRIPTION OF THE DRAWINGS

FIGS. 1A-1F show one embodiment of a floss dispenser 1000.

FIGS. 1G-1L show another embodiment of a floss dispenser 2000.

FIGS. 2A-2C show enlarged views of spout 1300 and cutter 1400.

FIG. 2D shows an enlarged cross-sectional side view of cutter 1400.

FIG. 3A shows one embodiment of feeder 1200.

FIGS. 3B-3D show various embodiments of rollers 1220 with a spring 1224.

FIGS. 3E-3H show examples of how rollers 1220 may be arranged.

FIG. 3I shows a front view of floss cartridge 2250 and a rear view of housing 2100.

FIGS. 3J-3N show one embodiment of a floss cartridge 2250.

FIGS. 3O-3P show a spool holder 1210 holding a spool of floss in horizontal and vertical orientations, respectively.

FIG. 3Q shows another embodiment of a floss cartridge 2250.

FIG. 4A shows one embodiment of light ring 1107.

FIGS. 4B-4C shows embodiments of light reflector 1108 and light reflector 2108, respectively.

FIGS. 5A-5F show one embodiment of a method of using floss dispenser 1000 in single user mode.

FIGS. 6A-6F show another embodiment of a method for using floss dispenser 1000 in dual user mode.

FIG. 7A shows one embodiment of cutter 1400.

FIG. 7B shows cutter 1400 with one embodiment of a clearing device 1410.

FIGS. 8A-8F show one embodiment of a method of using cutter 1400 with a clearing wire 1411.

FIGS. 9A-9D show cutter 1400 with other embodiments of a clearing device 1410.

### DESCRIPTION

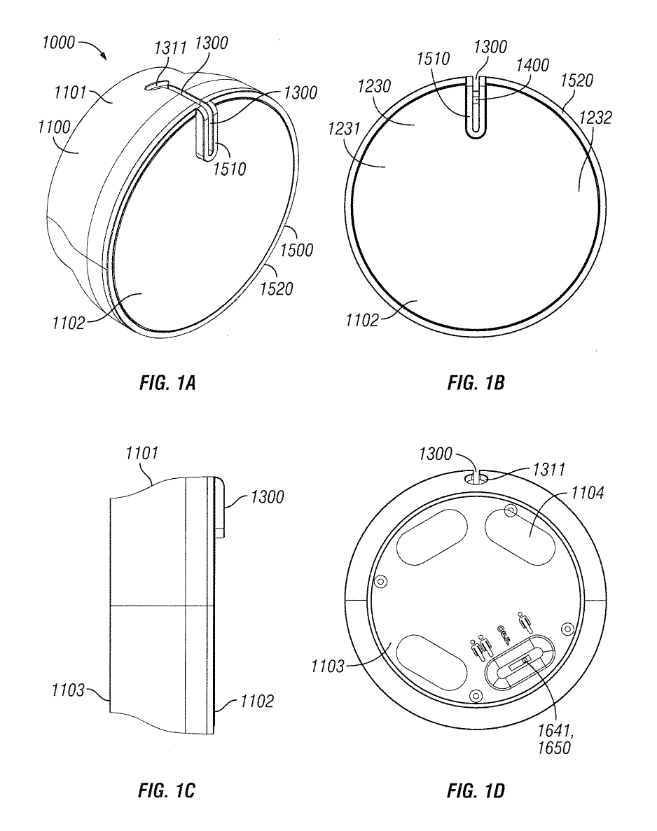

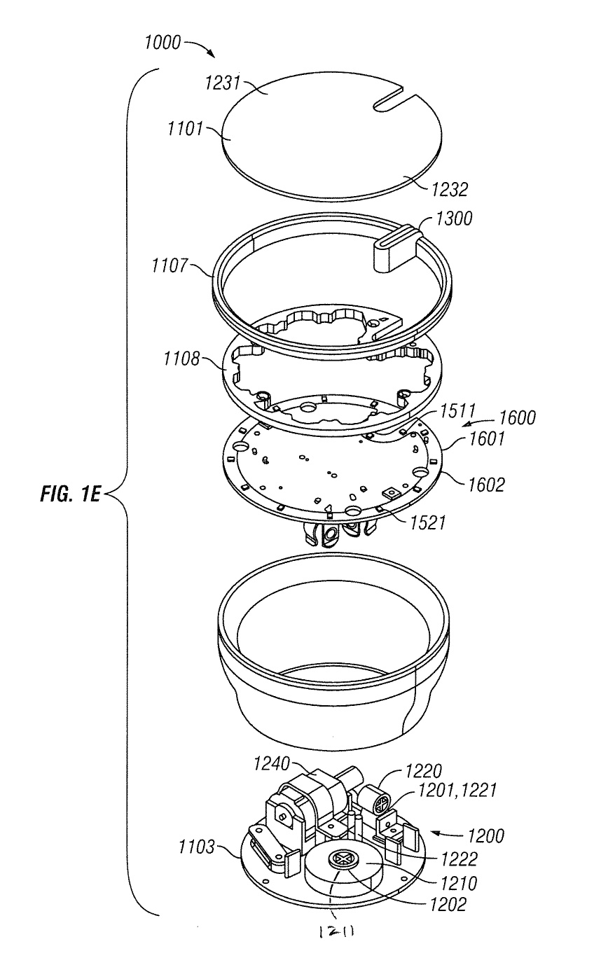

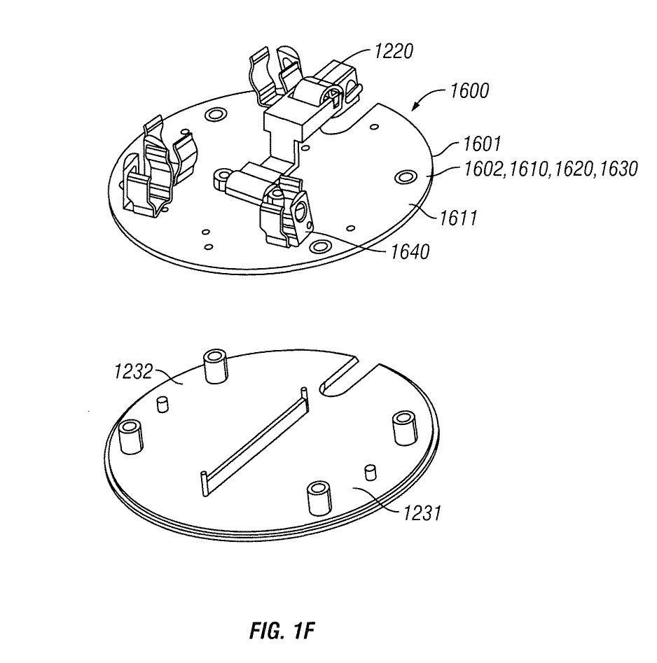

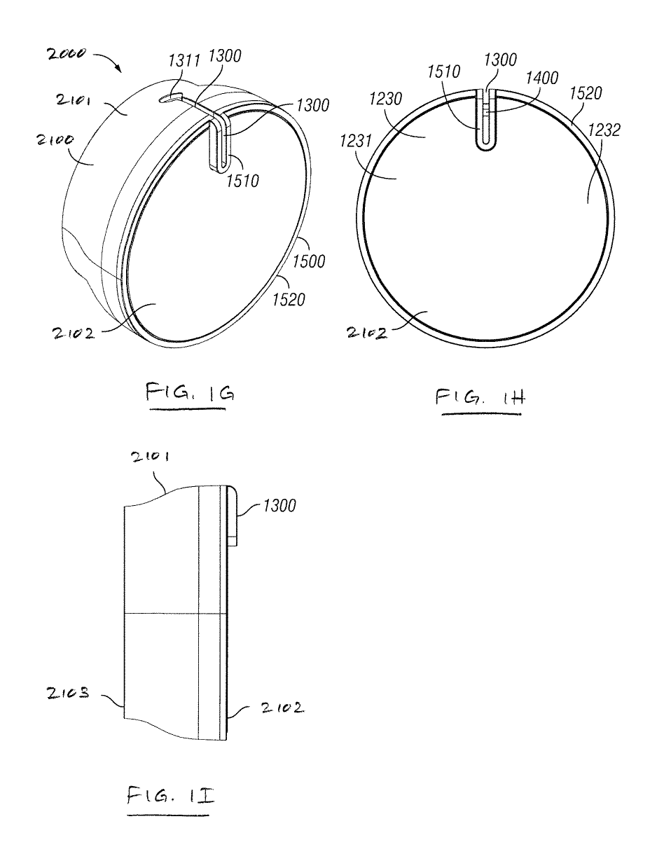

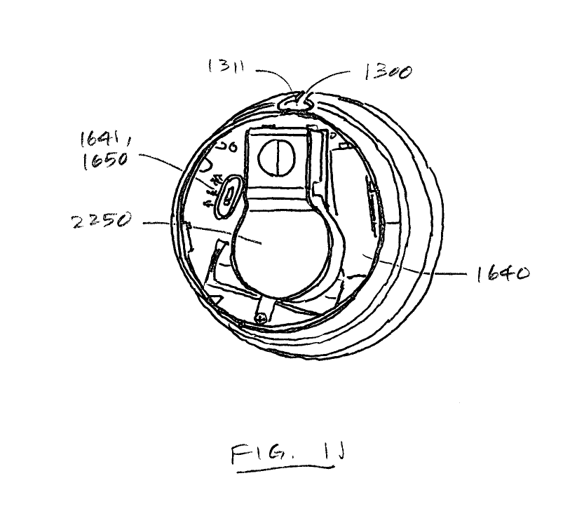

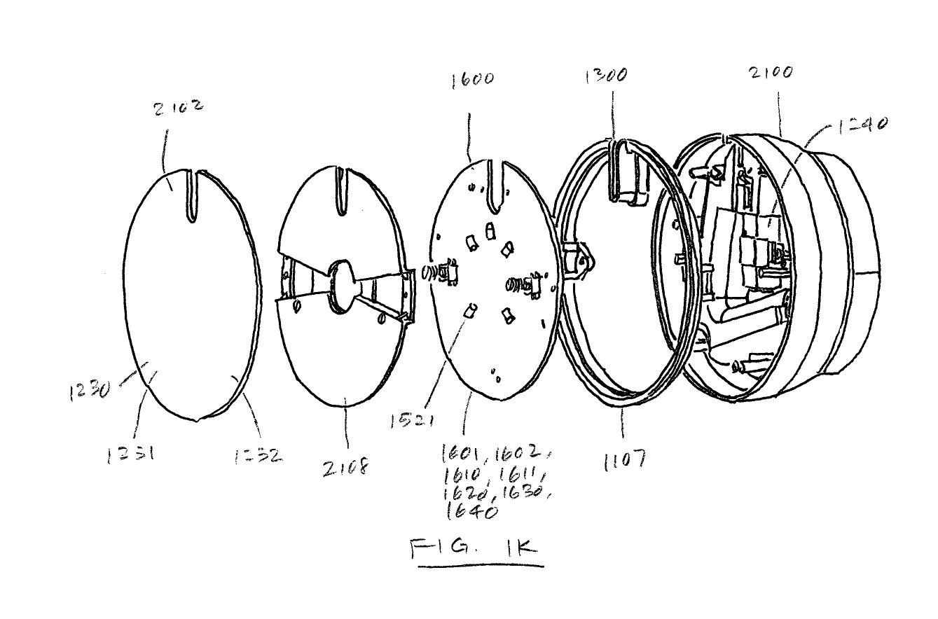

FIGS. 1A-1F show one embodiment of a floss dispenser 1000. FIGS. 1A-1D show perspective, front, side, and back views, respectively, of floss dispenser 1000. FIG. 1E shows a front exploded view of floss dispenser 1000. FIG. 1F shows a back exploded view of a portion of floss dispenser 1000.

Floss dispenser 1000 facilitates flossing. Floss dispenser 1000 may include a housing 1100, a feeder 1200, a spout 1300, and a cutter 1400.

Housing 1100 may include a top 1101, a front 1102, and a back 1103. Housing 1100 may be round or circular to resemble a clock and/or a mouth. Front 1102 of housing 1100 may be round or circular to resemble a face of a clock and/or a mouth. Housing 1100 may have a frustoconical shape. Front 1102 may have a diameter greater than back 1103 of housing 1100. Housing 1100 may be configured so that when housing 1100 is mounted to a mirror, housing 1100 combined with a reflection of housing 1100 resembles an hourglass. Alternatively, housing 1100 may be oval, rectangular, square, or any other suitable shape. Back 1103 may be removable to allow access to an interior of housing 1100.

Housing 1100 may include a mount 1104. Mount 1104 may be coupled to back 1103 of housing 1100 and/or any other part of housing 1100. Mount 1104 may include any one or any combination of a microsuction tape, a suction cup, an adhesive tape, a keyhole slot, a hook, or any other suitable coupling device. Mount 1104 may be configured to couple housing 1100 to a vertical surface and/or a horizontal surface. For example, mount 1104 may be configured to couple housing 1100 to a mirror, a wall, a counter, or a table.

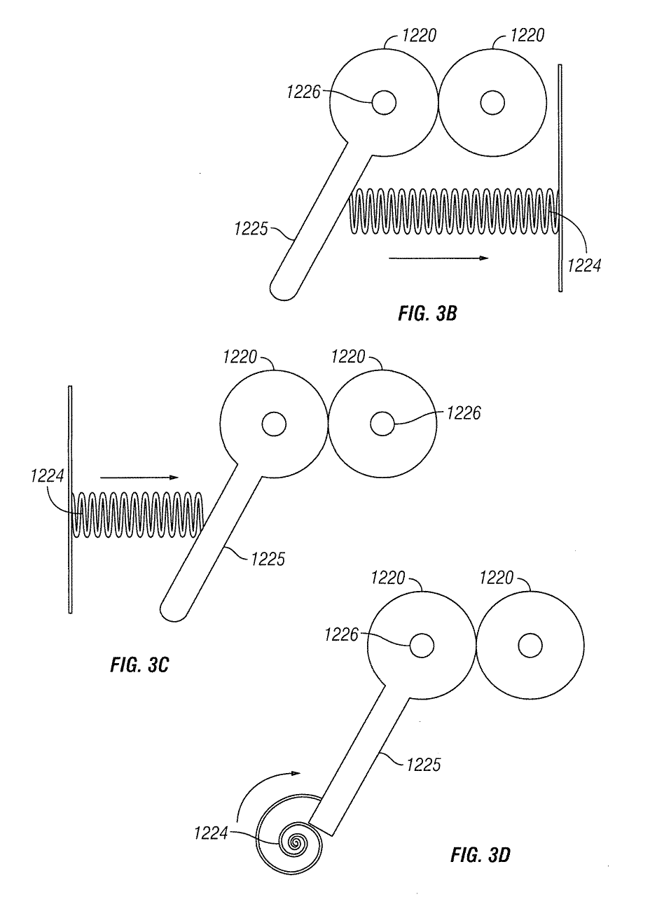

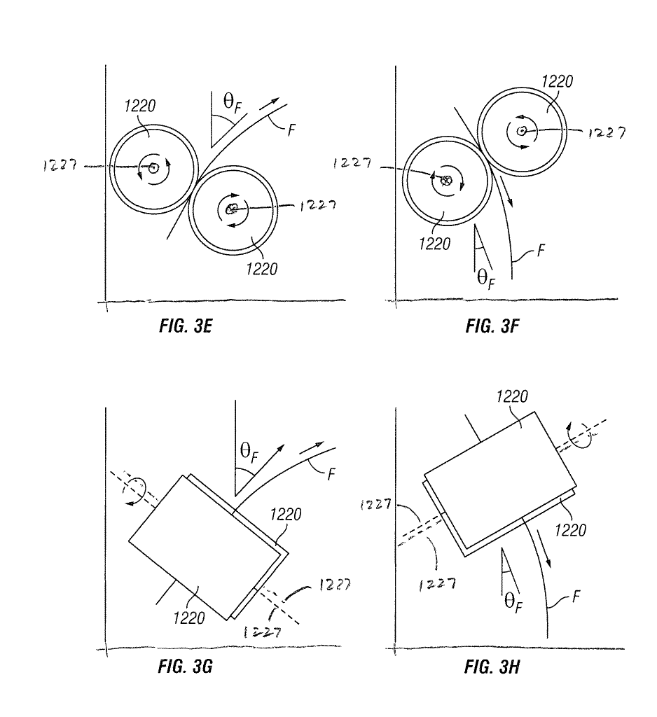

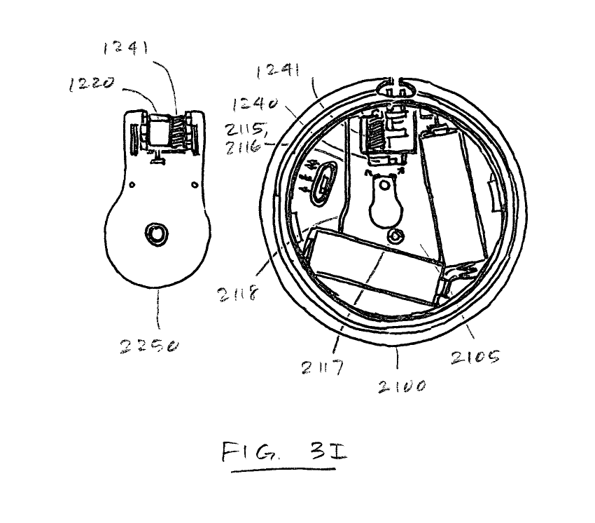

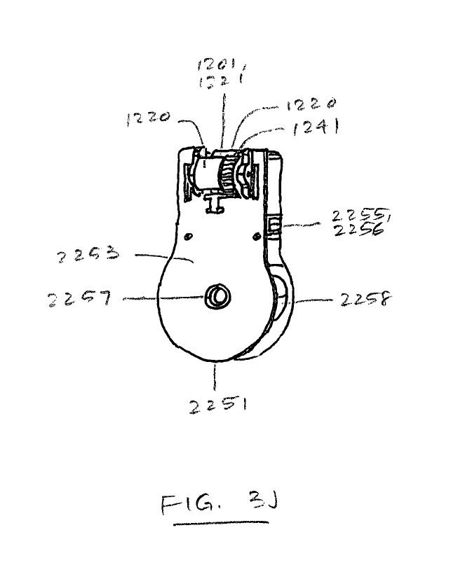

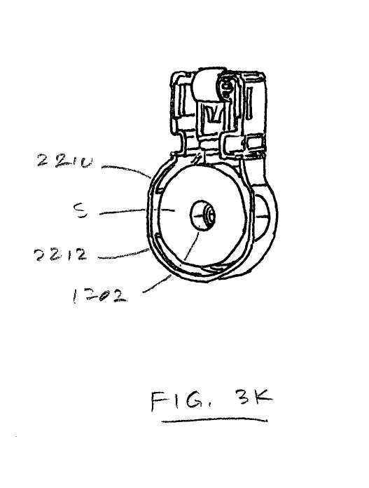

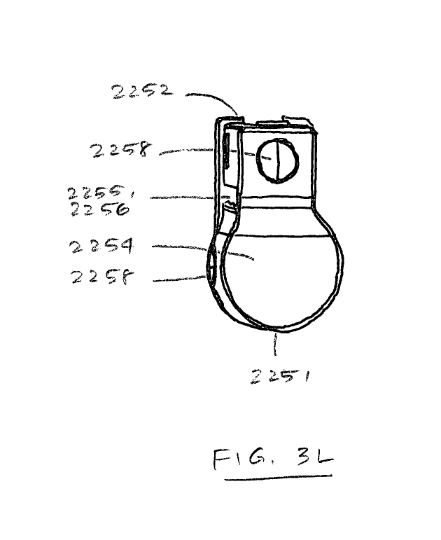

FIG. 3A shows one embodiment of feeder 1200. Feeder 1200 is coupled to housing 1100. Feeder 1200 is configured to feed floss. Feeder 1200 may be configured to feed floss toward top 1101 and/or front 1102 of housing 1100. Feeder 1200 may be configured to feed floss toward floss exit hole 1311 of housing 1100.

Feeder 1200 may include a feed point 1201. Feed point 1201 is a point from which floss is fed.

Feeder 1200 includes a spool holder 1210 configured to hold a spool S. Floss may be fed from spool S by two rollers 1220 which contact each other at a pinch point 1221, in which case feed point 1201 may be pinch point 1221. Alternatively, floss may be pulled from spool S by hand, in which case feed point 1201 may be a point where floss leaves spool S. Feeder 1200 may include a feed sensor 1202 configured to sense when floss has been fed. Feed sensor 1202 may include any one or any combination of a switch, a pressure sensor, a motion sensor, or any other suitable sensor.

Spool holder 1210 may include a spool post 1211 coupled to housing 1100. Spool holder 1210 may orient an axis of rotation of spool S in a horizontal orientation (as shown in FIG. 30), vertical orientation (as shown in FIG. 3P), or other orientation. Spool S may be disc-shaped, cylindrical, conical, or other suitable shape. Spool S may include a portion of floss that is colored differently to provide an indication to replace spool S.

Feeder 1200 may include a pair of rollers 1220. Rollers 1220 may be driven by a motor or by a user. Rollers 1220 may contact each other at a pinch point 1221. Rollers 1220 are configured to pull floss from spool holder 1210 and feed floss from pinch point 1221. Rollers 1220 may have a diameter of approximately 5 mm to 15 mm, or approximately 1 mm to 50 mm. Rollers 1220 may have different diameters. Rollers 1220 may rotate at a speed of approximately 400 rpm to 500 rpm, or approximately 10 rpm to 2000 rpm. Pinch point 1221 may be aligned with floss exit hole 1311. Pinch point 1221 may be positioned 5 cm or less from floss exit hole 1311.

Feeder 1200 may include one or more feed guides 1222. Feed guides 1222 may be placed before and/or after pinch point 1221 of rollers 1220. Feed guides 1222 may include any one or any combination of tubes, channels, grooves, holes, or any other suitable device. For example, feed guides 1222 may include a guide hole 1223 between spool holder 1210 and pinch point 1221. Feed guides 1222 may include floss exit hole 1311. Feed guides 1222 may be positioned between 1 mm and 50 mm from pinch point 1221. Feed guides 1222 are configured to guide floss through pinch point 1221 of rollers 1220.

FIGS. 3B-3D show various embodiments of rollers 1220 with a spring 1224. FIG. 3B shows roller 1220 with spring 1224 in tension. FIG. 3C shows roller 1220 with spring 1224 in compression. FIG. 3D shows roller 1220 with spring 1224 in torsion. Rollers 1220 may be biased against each other. For example, two rollers 1220 may be biased against each other with a force of approximately 200 grams to 300 grams, or approximately 10 grams to 1000 grams. Rollers 1220 may be biased against each other with spring 1224. Spring 1224 may be in tension, compression, or torsion. Rollers 1220 may be biased against each other with a weight or any other suitable device. One or both rollers 1220 may be mounted on an arm 1225. One or both rollers 1220 may include bearings 1226.

FIGS. 3E-3H show examples of how rollers 1220 may be arranged.

FIGS. 3E-3F shows rollers 1220 arranged with their axes of rotation 1227 parallel to a vertical surface. Rollers 1220 may have axes of rotation 1227 that are horizontal or level. Rollers 1220 may have axes of rotation 1227 that are parallel to each other. Rollers 1220 may have axes of rotation 1227 that are at different heights or levels from each other. One roller 1220 may have an axis of rotation 1227 that is higher than an axis of rotation 1227 of the other roller 1220. By adjusting the heights or positions of rollers 1220 with respect to each other, floss F may be fed at a desired feed angle Θ_{F}. The feed angle Θ_{F} may be a tangent of pinch point 1201. The feed angle Θ_{F} may be between approximately 0 degrees and 90 degrees from vertical, or between approximately 0 degrees and 15 degrees from vertical.

FIGS. 3G-3H shows rollers 1220 arranged with their axes of rotation 1227 at an angle to a horizontal surface. Rollers 1220 may have axes of rotation 1227 that are parallel to each other. By adjusting the angle of rollers 1220 relative to a horizontal surface, floss F may be fed at a desired feed angle Θ_{F}. The angle of rollers 1220 may be between approximately 0 degrees and 90 degrees from horizontal, or between approximately 0 degrees and 15 degrees from horizontal. The feed angle Θ_{F} may be normal to axes of rotation 1227. Feed angle Θ_{F} may be between approximately 0 degrees and 90 degrees from vertical, or between approximately 0 degrees and 15 degrees from vertical.

Referring back to FIGS. 1A-1F, feeder 1200 may include at least one button 1230. Button 1230 may include a mechanical button and/or a touch-sensitive button such as a capacitive switch. Button 1230 may be coupled to housing 1100. Button 1230 may be coupled to front 1102 of housing 1100 and/or any other part of housing 1100. For a front 1102 of housing 1100 that is round or circular, first button 1231 and second button 1232 may be formed as two halves of a circle or a disc, and form at least a portion of front 1102 of housing 1100. Multiple buttons 1230 may be labeled to correspond to different users. For example, a first button 1231 may correspond to a first user, and a second button 1232 may correspond to a second user.

Button 1230 is configured to cause floss to be fed from spool holder 1210. Button 1230 may be configured to cause floss to be fed either through a user-powered mechanism or an electrically-powered mechanism. Alternatively, in addition to or in place of button 1230, floss dispenser 1000 may include any one or any combination of a motion sensor, a microphone configured to receive a voice and/or sound command, a lever, a crank, a knob, or any other suitable controls or devices for feeding floss. Alternatively, floss dispenser 1000 may include no buttons or mechanisms, and floss is fed by pulling floss from spool holder 1210 by hand.

Feeder 1200 may include a motor 1240. Motor 1240 may be connected to a motor controller 1630. Motor 1240 may include any one or any combination of a DC motor, an AC motor, a stepper motor, or any other suitable actuator. Motor 1240 is coupled to one or both rollers 1220. Motor 1240 is configured to rotate rollers 1220. Motor 1240 may be configured to rotate rollers 1220 with sufficient speed to feed 18 inches of floss in approximately 0.1 seconds to 10 seconds, or approximately 3 seconds or less. Motor 1240 may have a speed of approximately 10 rpm to 20000 rpm.

Feeder 1200 may include gearing 1241. Gearing 1241 may couple motor 1240 to one or both rollers 1220. Gearing 1241 may be configured to gear down an output from motor 1240 to obtain a desired speed and/or torque at rollers 1220. Gearing 1241 may include any one or any combination of a spur gear, a worm gear, a belt, or any other gearing.

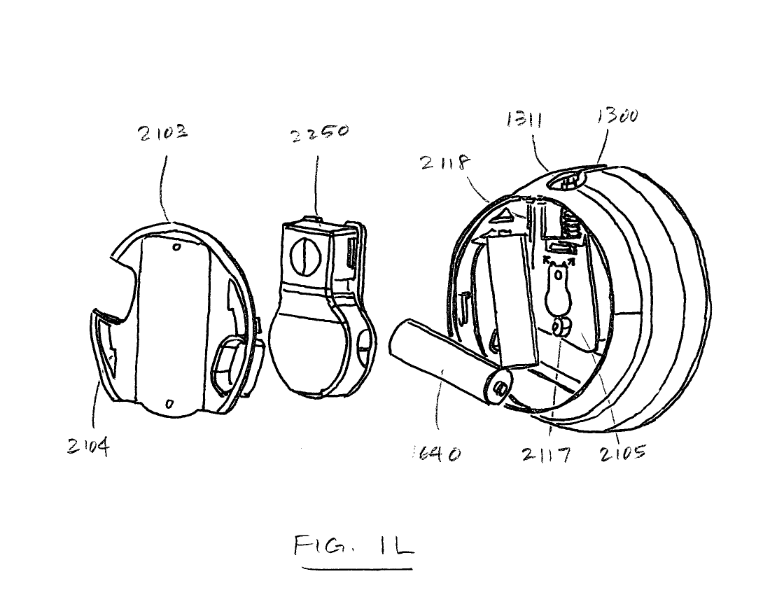

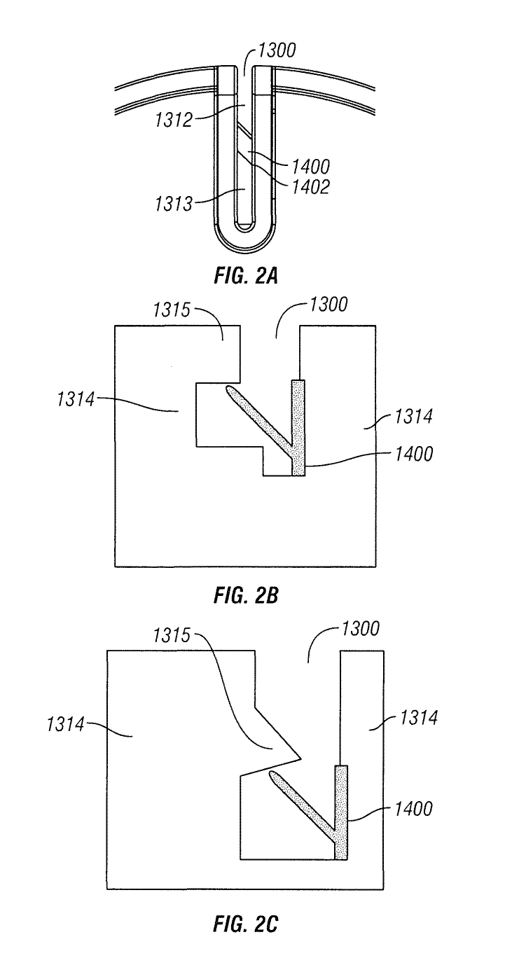

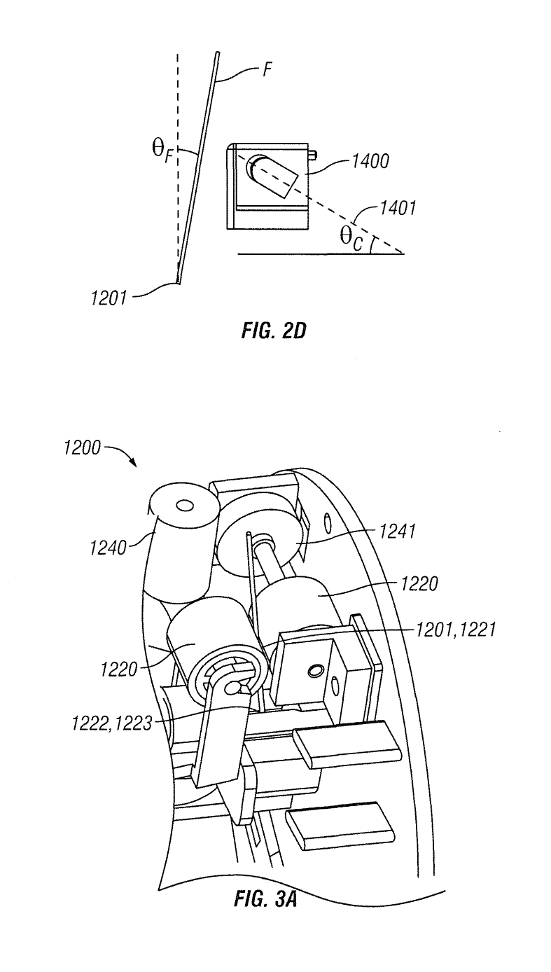

FIGS. 2A-2C show enlarged views of spout 1300 and cutter 1400. FIG. 2A shows an enlarged front view of one embodiment of spout 1300 and cutter 1400. FIGS. 2B-2C show enlarged front views of two embodiments of guide walls 1314 and cutter 1400.

Spout 1300 is formed in housing 1100. Spout 1300 may include an opening formed through a wall of housing 1100. Spout 1300 may be elongate or any other suitable shape. Spout 1300 may be at least partially formed in top 1101 and/or front 1102 of housing 1100. Spout 1300 may be vertical. Spout 1300 may extend from top 1101 of housing 1100 to front 1102 of housing 1100 and at least partially down front 1102 of housing 1100. Alternatively, spout 1300 may be formed in any other part of housing 1100. Spout 1300 is configured to guide to cutter 1400 floss fed from feeder 1200.

Spout 1300 may include a floss exit hole 1311. Floss exit hole 1311 may be round, elongate, or any other suitable shape. Floss exit hole 1311 may include at least a portion having a width of approximately 2 mm to 8 mm. Floss exit hole 1311 may be formed with or discrete from spout 1300. Floss exit hole 1311 is configured to allow floss to exit housing 1100.

Spout 1300 includes a cutter entry 1312 and a cutter exit 1313. Cutter entry 1312 may be positioned above cutter exit 1313. Cutter entry 1312 may include guide walls 1314. At least a portion of guide walls 1314 may be any one or any combination of parallel, V shaped, or any other suitable shape. Guide walls 1314 may be configured to reduce the likelihood that floss will miss or bypass cutter 1400. Guide walls 1314 may include a guard 1315 configured to reduce the likelihood that floss will miss or bypass cutter 1400.

Cutter 1400 is coupled to housing 1100. Cutter 1400 may be coupled between cutter entry 1312 and cutter exit 1313. Cutter 1400 may include a stamped floss cutter. Cutter 1400 may include a blade and/or other suitable cutting device. Cutter 1400 may be manual or powered. Cutter 1400 is configured to cut floss. Cutter 1400 may include a cutter sensor 1402 configured to sense when cutter 1400 has cut floss. Cutter sensor 1402 may include any one or any combination of a switch, a pressure sensor, a motion sensor, or any other suitable sensor.

Spout 1300 may be configured so that floss fed from feed point 1201 will be guided into cutter entry 1312. Spout 1300 may be configured so that floss fed from feed point 1201 may be draped over cutter 1400. For example, spout 1300 may be positioned so that when a length of floss is fed, floss will fall under its own weight into cutter entry 1312 and drape over cutter 1400. As another example, spout 1300 may be positioned so that when a length of floss is fed, spout 1300 will be positioned under at least a portion of the length of floss. As yet another example, spout 1300 may extend from floss exit hole 1311 to cutter entry 1312 so that a length of floss may be pulled by a user from floss exit hole 1311 to cutter entry 1312. Floss may be draped over cutter 1400 by pulling floss from cutter entry 1312 towards cutter exit 1313. Floss may be cut by pulling floss into cutter 1400.

Spout 1300 and/or cutter 1400 may be configured to reduce the likelihood of injury to a user. For example, spout 1300 may be sufficiently narrow to prevent the entry of a finger or other body part. As another example, cutter 1400 may be arranged with a sharp or cutting surface out of reach of a finger or other body part.

FIG. 2D shows an enlarged cross-sectional side view of cutter 1400. Floss F may be fed from feed point 1201 in an upward direction, so that floss F may fall under its own weight. For example, floss F may be fed at a feed angle Θ_{F} of approximately 10 degrees from vertical, or between approximately 0 degrees and 90 degrees from vertical.

Cutter 1400 may be positioned relative to floss F so that it is capable of cutting floss. For example, cutter 1400 may be positioned with a longitudinal axis 1401 at a cutter angle Θ_{C} of approximately 45 degrees to 135 degrees from horizontal.

Cutter 1400 may be positioned higher than feed point 1201. Floss F may have sufficient stiffness to be fed above cutter 1400, before falling under its own weight. This allows a length of floss F to be draped over cutter 1400, and may facilitate the cutting of floss when floss F is pulled downward.

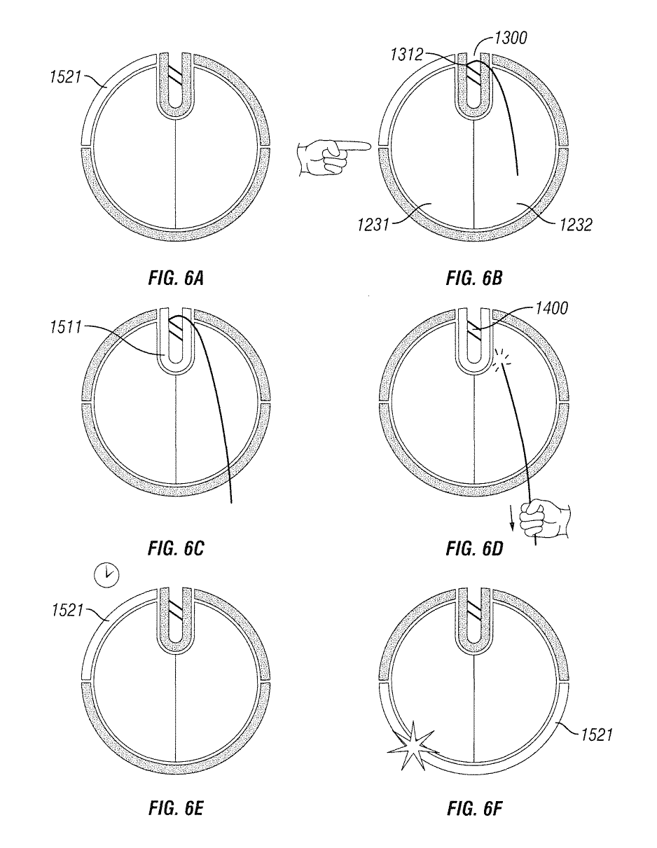

FIG. 7A shows one embodiment of cutter 1400. Cutter 1400 may include a base 1403 and a tongue 1404. Tongue 1404 may be coupled to base 1403 to form a notch 1405 between tongue 1404 and base 1403. Tongue 1404 may have a sharpened edge 1406 configured to cut floss pulled into notch 1405. Notch 1405 may have an entrance 1407.

FIG. 7B shows cutter 1400 with one embodiment of a clearing device 1410. A cut end of a spool of floss may become stuck in notch 1405 when floss is pulled into notch 1405 and cut by cutter 1400. Clearing device 1410 is configured to release the end stuck in notch 1405. Clearing device 1410 releases the end from notch 1405 so that another length of floss may be fed from the spool without the end being stuck in notch 1405.

Clearing device 1410 may include a clearing wire 1411. Clearing wire 1411 may be coupled across an entrance 1407 of notch 1405. Clearing wire 1411 may be fixed at one or both ends. Clearing wire 1411 may be made of a springy or resilient material. Clearing wire 1411 may be made of a metal, plastic, wood, or other suitable material. Clearing wire 1411 may be configured to bow or flex when floss is pulled into notch 1405. Clearing wire 1411 may be configured to unbow or unflex and push or urge out an end of a spool of floss stuck in notch 1405 after the floss is cut by cutter 1400.

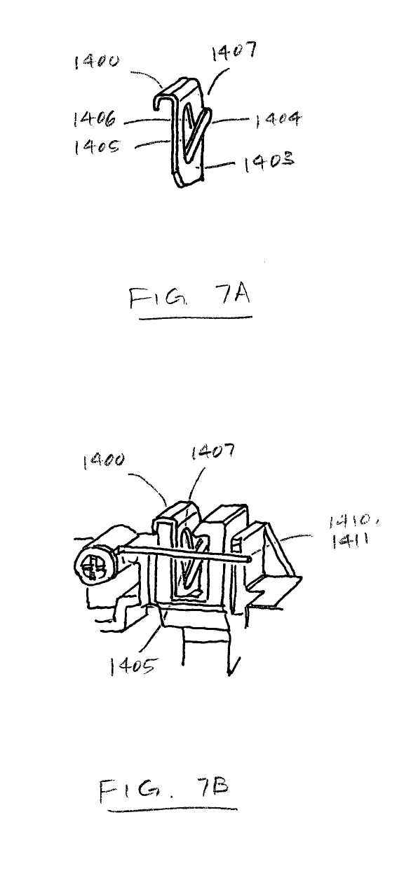

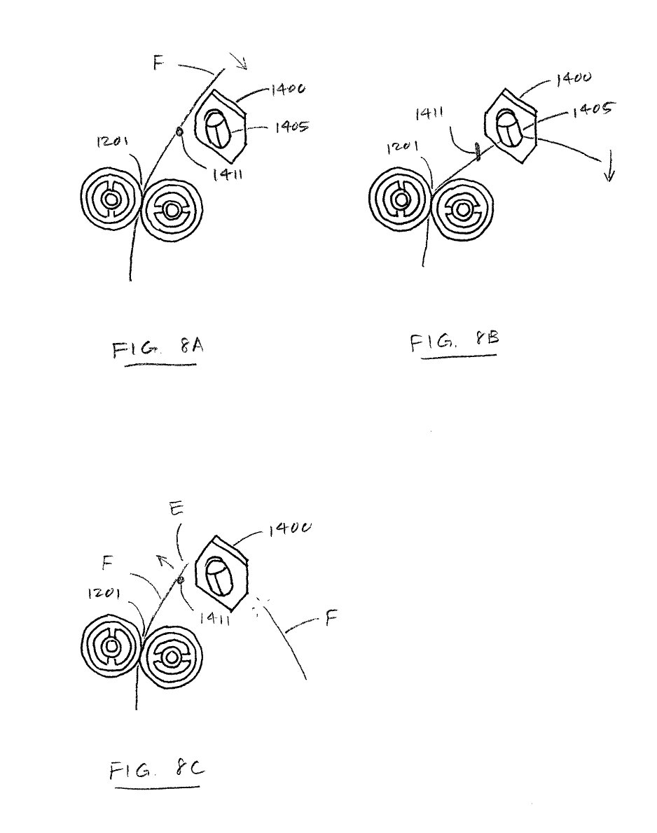

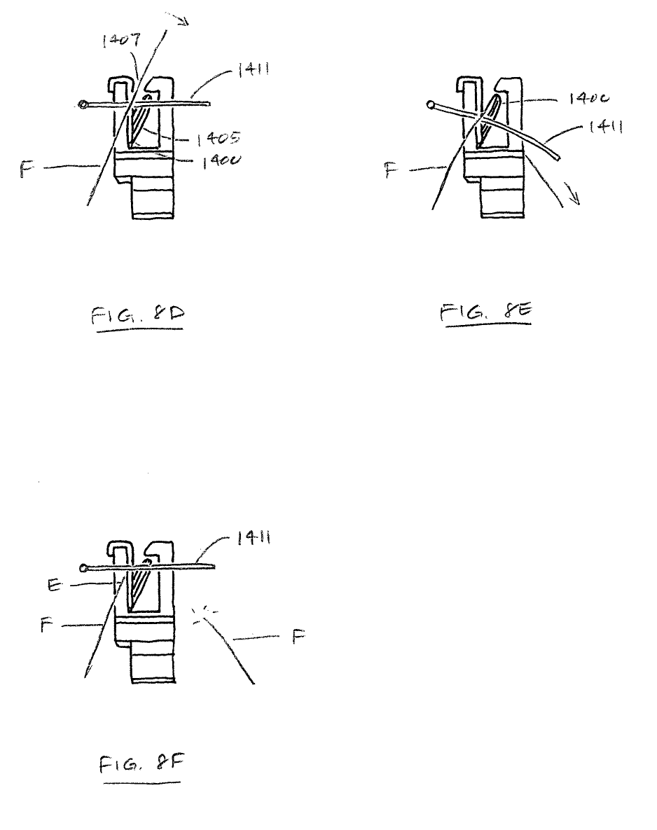

FIGS. 8A-8F show one embodiment of a method of using cutter 1400 with a clearing wire 1411. FIGS. 8A and 8D show side and back views of clearing wire 1411 in an unbowed or unflexed state. FIGS. 8B and 8E show side and back views of clearing wire 1411 in a bowed or flexed state. Clearing wire 1411 is bowed or flexed by floss F when floss F is pulled into notch 1405. When floss F is cut, an end E of floss F may be stuck in notch 1405. FIGS. 8C and 8F show side and back views of clearing wire 1411 returned to the unbowed or unflexed state. After floss F is cut, clearing wire 1411 is free to unbow or unflex and pushes or urges end E of floss F out of notch 1405.

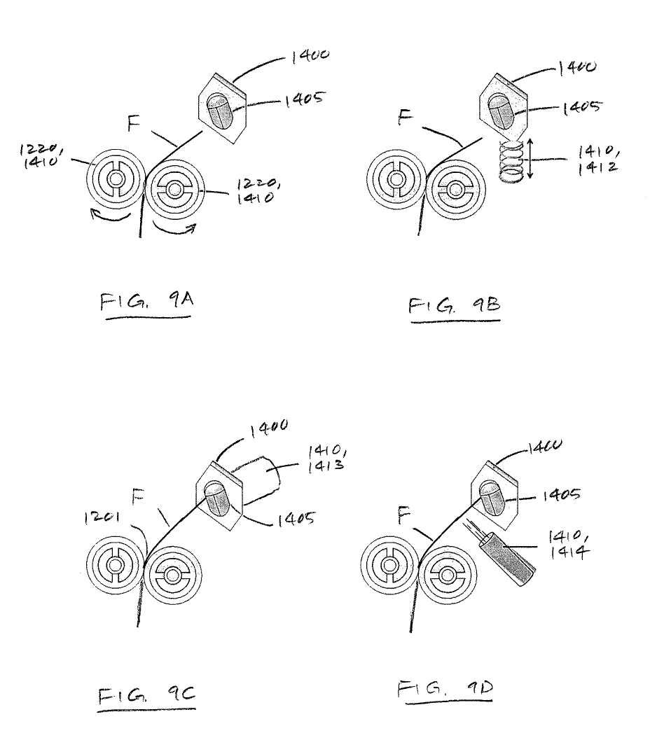

FIGS. 9A-9D show cutter 1400 with other embodiments of a clearing device 1410.

FIG. 9A shows a clearing device 1410 including rollers 1220 capable of reversing a direction of rotation. Rollers 1220 may be driven in a reverse direction to pull floss F out of notch 1405.

FIG. 9B shows a clearing device 1410 including a clearing spring 1412. Clearing spring 1412 may be coupled to cutter 1400. Clearing spring 1412 compresses when floss F is pulled into notch 1405. When clearing spring 1412 uncompresses, floss F may be released from notch 1405.

FIG. 9C shows a clearing device 1410 including a clearing motor 1413. Clearing motor 1413 may be coupled to cutter 1400. Clearing motor 1413 is configured to rotate cutter 1400. Clearing motor 1413 may be configured to rotate cutter 1400. Clearing motor 1413 may rotate cutter 1400 toward feed point 1201 to release floss F from notch 1405. Clearing motor 1413 may be configured to rotate cutter 1400 in either direction. Clearing motor 1413 may rotate cutter 1400 360 degrees or more. Alternatively, clearing device 1410 may include a torsion spring or other device configured to rotate cutter 1400.

FIG. 9D shows a clearing device 1410 including a clearing blower 1414. Clearing blower 1414 may be positioned to blow a gas at floss F to push floss F out of notch 1405.

Referring back to FIGS. 1A-1F, floss dispenser 1000 may include a display 1500. Display 1500 may include a spout display 1510. Spout display 1510 may include an LCD display and/or any other suitable display.

Spout display 1510 is configured to indicate floss is ready to be cut. Spout display 1510 may indicate for a predetermined period of time, or until the floss has been cut. For example, spout display 1510 may indicate for approximately 3 seconds to 10 seconds after floss has been fed to spout 1300. Spout display 1510 may indicate by any one or any combination of turning on continuously, flashing, “breathing,” pulsating, indicating a direction to pull the floss in order to cut the floss, or any other suitable manner.

Spout display 1510 may include one or more spout lights 1511. Spout lights 1511 may include LEDs and/or any other suitable lights. For example, spout lights 1511 may include three LEDs, or one to 10 LEDs. Spout lights 1511 may be configured to display different colors. For example, spout lights 1511 may include RGB LEDs and/or LEDs of different colors. Spout lights 1511 may be coupled to one or more edges and/or guide walls 1314 of spout 1300. Spout lights 1511 may light progressively or in a wave from cutter entry 1312 to cutter exit 1313 to indicate a direction in which floss should be pulled.

Display 1500 may include a reminder display 1520. Reminder display 1520 may include an LCD display and/or any other suitable display. Spout display 1510 and reminder display 1520 may be the same or different displays.

Reminder display 1520 is configured to display reminders to floss. Reminder display 1520 may display a reminder to floss after a predetermined period of time has passed. Reminder display 1520 may display a reminder to floss after a predetermined period of time has passed since a last flossing. For example, reminder display 1520 may display a reminder approximately 22 hours after floss was last fed, or approximately 20 hours after the last reminder if no floss was fed during the last reminder. Reminder display 1520 may display a reminder for a predetermined period of time, or until the floss has been cut. For example, reminder display 1520 may display a reminder for approximately 4 hours. Reminder display 1520 may display a reminder by any one or any combination of turning on continuously, flashing, “breathing,” pulsating, or any other suitable manner. Reminder display 1520 may be configured to display reminders to multiple users. For example, reminder display 1520 may indicate for which particular user a reminder is intended. Reminder display 1520 may be configured to display a reminder only when a user is detected in a vicinity of floss dispenser 1000. For example, any one or any combination of a motion sensor, light sensor, or microphone may be used to detect a user in the vicinity of floss dispenser 1000.

Reminder display 1520 may be configured to display a graphical or symbolic representation. For example, reminder display 1520 may be configured to display a reward such as a smile after a user has flossed. As another example, reminder display 1520 may be configured to display a frown as a reminder to floss.

Reminder display 1520 may be configured to indicate a portion of a mouth to be flossed, such as a quadrant of the mouth to be flossed. Reminder display 1520 may be configured to indicate different portions of a mouth to be flossed in sequence, each for a predetermined period of time. For example, reminder display 1520 may be configured to indicate an upper left quadrant, a lower left quadrant, a lower right quadrant, and an upper right quadrant, each for approximately 30 seconds.

Reminder display 1520 may be configured to provide a timer to display a recommended amount of flossing time. Reminder display 1520 may be configured to provide a timer after floss has been fed. Reminder display 1520 may be configured to display an elapsed time and/or a remaining time. For example, reminder display 1520 may be configured to display a recommended flossing time of approximately 2 minutes, which starts counting down after button 1230 is operated. Reminder display 1520 may be configured to display time elapsed since last flossing and/or time remaining until next recommended flossing. Reminder display 1520 may be configured to display the time of last flossing and/or the time of next recommended flossing.

Reminder display 1520 may include one or more reminder lights 1521. Reminder lights 1521 may include LEDs and/or any other suitable lights. For example, reminder lights 1521 may include 12 LEDs, or one to 50 LEDs. Reminder lights 1521 may be coupled to front 1102 of housing 1100 in a circle. Reminder lights 1521 may be coupled to housing 1100 in a square or any other arrangement. Reminder lights 1521 may be coupled along a perimeter of front 1102 of housing 1100. Reminder lights 1521 may be coupled to any other part of housing 1100.

Reminder lights 1521 may be arranged to display a graphical or symbolic representation. For example, reminder lights 1521 may be arranged in a curve that resembles a smile. For a front 1102 of housing 1100 that is circular, reminder lights 1521 may be arranged along a perimeter of a lower half of front 1102 of housing 1100 to resemble a smile. One or more reminder lights 1521 in a smile may be lit more brightly than other reminder lights 1521 in the smile to resemble a “sparkle” in the smile. As another example, reminder lights 1521 may be arranged in a curve that resembles a frown. For a front 1102 of housing 1100 that is circular, reminder lights 1521 may be arranged along a perimeter of an upper half of front 1102 of housing 1100 to resemble a frown. Reminder lights 1521 may be configured to display different colors. For example, reminder lights 1521 may include RGB LEDs and/or LEDs of different colors.

Reminder lights 1521 may be configured to display reminders for multiple users. For example, multiple reminder lights 1521 may be labeled to correspond to different users. As another example, multiple reminder lights 1521 coupled to different parts of housing 1100 may correspond to different users.

Reminder lights 1521 may be configured to indicate a portion of a mouth to be flossed. For example, reminder lights 1521 may be configured to indicate a quadrant of the mouth to be flossed. Reminder lights 1521 may be configured to indicate different portions of a mouth to be flossed in sequence, each for a predetermined period of time. For example, reminder lights 1521 in an upper left quarter of front 1102 of housing 1100 may be used to indicate that an upper left quadrant of the mouth is to be flossed, then reminder lights 1521 in a lower left quarter of front 1102 of housing 1100 may be used to indicate that a lower left quadrant of the mouth is to be flossed, and so on, each quadrant for approximately 30 seconds, for a total of approximately 2 minutes for the entire mouth.

Reminder lights 1521 may be configured to display a recommended amount of flossing time. Reminder lights 1521 may be arranged in a circle or other shape that resembles a face of a clock. Reminder lights 1521 may be configured to display an elapsed flossing time and/or a remaining flossing time. For example, reminder lights 1521 may be configured to display a remaining flossing time of approximately 2 minutes which starts counting down after floss has been dispensed. Reminder lights 1521 may be controlled to resemble a timer counting up or down. For example, all reminder lights 1521 may be turned on, and then turned off one at a time over a period of approximately 2 minutes in a countdown or racetrack fashion, after which all reminder lights 1521 are off. Reminder lights 1521 may be configured to display time elapsed since last flossing and/or time remaining until next flossing.

Floss dispenser 1000 may include electronics 1600. Electronics 1600 may be coupled to housing 1100.

Electronics 1600 may include a timer 1610. Timer 1610 may be coupled to any one or any combination of feed sensor 1202, cutter sensor 1402, or button 1230. Timer 1610 may be configured to determine whether a predetermined period of time has passed since an event. For example, timer 1610 may be configured to determine whether a predetermined period of time has passed since floss was last dispensed and/or since a user last flossed. Timer 1610 may be configured to provide an amount of flossing time.

Timer 1610 may be configured to give visual and/or audio indications. Timer 1610 may be connected to reminder display 1520 and/or reminder lights 1521 to give visual indications. Timer 1610 may be connected to a buzzer or speaker 1611 to give audio indications.

Electronics 1600 may include a display controller 1620. Display controller 1620 is configured to control display 1500. Display controller 1620 may be configured to control spout lights 1511 and/or reminder lights 1521.

Electronics 1600 may include a motor controller 1630. Motor controller 1630 is configured to control motor 1240. Motor controller 1630 may be configured to provide power to motor 1240. Motor controller 1630 may be configured to turn on motor 1240 for a desired period of time. Alternatively, motor controller 1630 may be configured to turn on motor 1240 for as long as button 1230 is operated. Motor controller 1630 may be configured to control a speed of motor 1240. Motor controller 1630 may be configurable to adjust a length of floss fed. For example, motor controller 1630 may be configured to feed approximately 18 inches, or approximately 10 inches to 30 inches of floss.

Electronics 1600 may include a power source 1640. Power source 1640 is configurable to provide power to one or more components of electronics 1600. Power source 1640 may include any one or any combination of a battery, an AC adapter, a solar cell, or any other suitable power source. Power source 1640 may include a power switch 1641. Power switch 1641 is configurable to turn power source 1640 on and off. Power source 1640 may include a power level indicator configured to indicate how much power is remaining.

Electronics 1600 may include a user selector switch 1650. User selector switch 1650 may allow floss dispenser 1000 to be configurable for use with a single user or two or more users. Power switch 1641 and user selector switch 1650 may be the same switch or different switches.

Electronics 1600 may include a printed circuit board (PCB) 1601. Any one or any combination of timer 1610, display controller 1620, motor controller 1630, power source 1640, or user selector switch 1650 may be connected to PCB 1601. Any one or any combination of timer 1610, display controller 1620, or motor controller 1630 may be implemented in one or more integrated chips 1602.

Housing 1100 may include a light ring 1107 and/or a light reflector 1108.

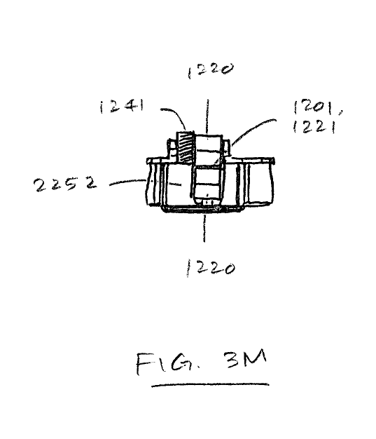

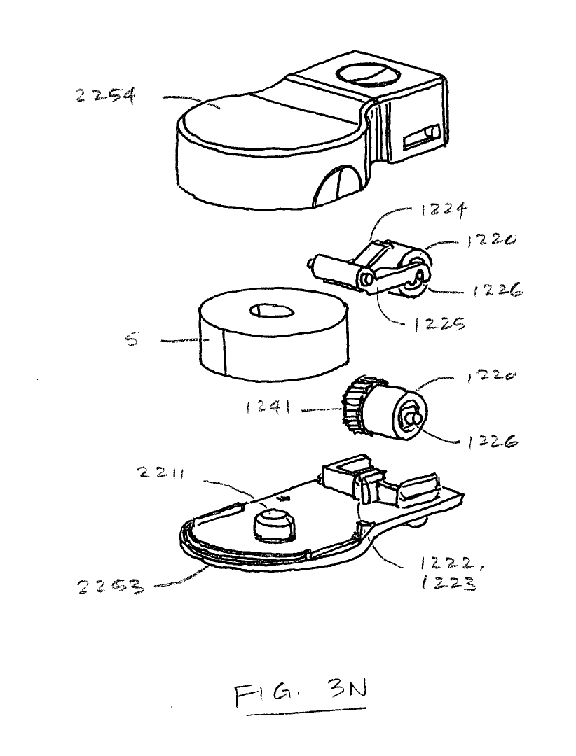

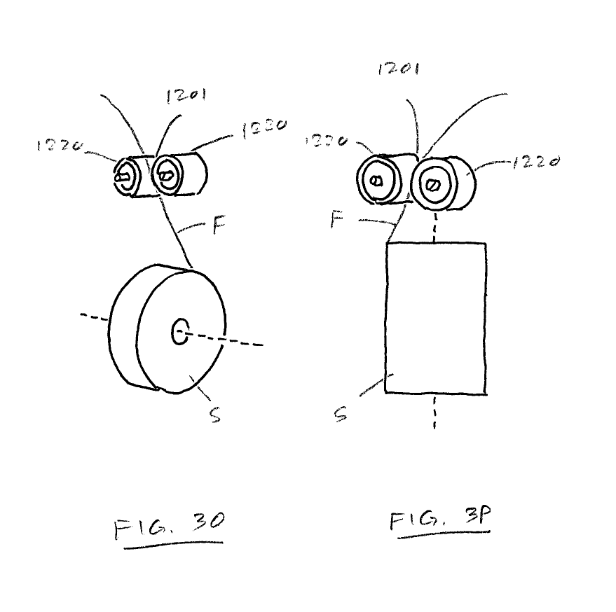

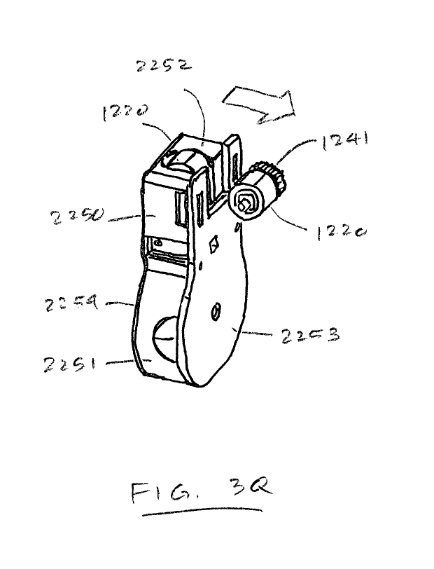

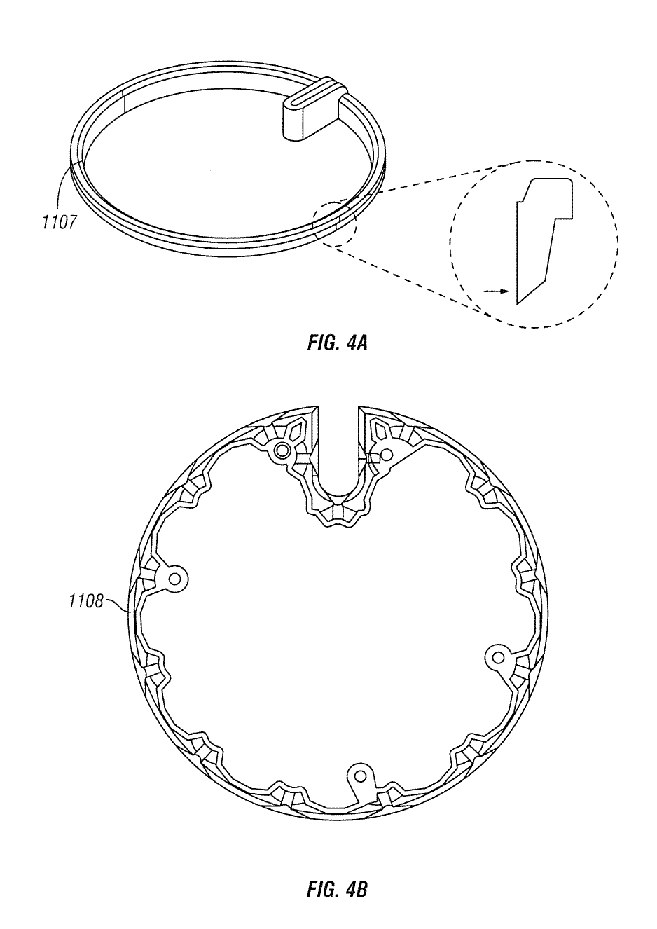

FIG. 4A shows one embodiment of light ring 1107. Light ring 1107 may be coupled to front 1102 of housing 1100. Light ring 1107 may be coupled to a perimeter of front 1102 of housing 1100. Light ring 1107 may be coupled to any other part of housing 1100. Light ring 1107 may be circular. Light ring 1107 may be square or any other shape. One or more spout lights 1511 and/or one or more reminder lights 1521 may be arranged in a vicinity of light ring 1107. For example, one or more spout lights 1511 and/or one or more reminder lights 1521 may be positioned approximately 0.1 mm to 10 mm from light ring 1107. Light ring 1107 may be at least partially made of a semi-transparent and/or diffusive material. For example, light ring 1107 may be made of a semi-opaque plastic. Light ring 1107 is configured to diffuse light from one or more spout lights 1511 and/or one or more reminder lights 1521. Light ring 1107 may cause light from spout lights 1511 and/or reminder lights 1521 to be emitted more uniformly along light ring 1107. Light ring 1107 may increase an amount of light from spout lights 1511 and/or reminder lights 1521 that is emitted from housing 1100.

FIG. 4B shows one embodiment of light reflector 1108. Light reflector 1108 may be coupled to front 1102 of housing 1100. Light reflector 1108 may be coupled to a perimeter of front 1102 of housing 1100. Light reflector 1108 may be arranged next to light ring 1107. Light reflector 1108 may be coupled to any other part of housing 1100. One or more spout lights 1511 and/or one or more reminder lights 1521 may be arranged in a vicinity of light reflector 1108. For example, one or more spout lights 1511 and/or one or more reminder lights 1521 may be positioned approximately 0.1 mm to 10 mm from light reflector 1108. Light reflector 1108 may be at least partially made of a reflective material. Light reflector 1108 may include white and/or light-colored walls. Light reflector 1108 may include parabolic and/or hyperbolic walls. Light reflector 1108 may increase an amount of light from spout lights 1511 and/or reminder lights 1521 that is emitted from housing 1100.

FIGS. 1G-1L show another embodiment of a floss dispenser 2000. FIGS. 1G-1J show a perspective, front, side, and back views, respectively, of floss dispenser 2000. FIGS. 1K-1L show front and back exploded views of floss dispenser 2000, respectively.

Floss dispenser 2000 may include a housing 2100, a floss cartridge 2250, a spout 1300, and a cutter 1400.

Housing 2100 may include a top 2101, a front 2102, and a back 2103. Housing 2100 may be round or circular to resemble a clock and/or a mouth. Front 2102 of housing 2100 may be round or circular to resemble a face of a clock and/or a mouth. Housing 2100 may have a frustoconical shape. Front 2102 may have a diameter greater than back 2103 of housing 2100. Housing 2100 may be configured so that when housing 2100 is mounted to a mirror, housing 2100 combined with a reflection of housing 2100 resembles an hourglass. Alternatively, housing 2100 may be oval, rectangular, square, or any other suitable shape. Back 2103 may be removable to allow access to an interior of housing 2100.

Housing 2100 may include a mount 2104. Mount 2104 may be coupled to back 2103 of housing 2100 and/or any other part of housing 2100. Mount 2104 may include any one or any combination of a microsuction tape, a suction cup, an adhesive tape, a keyhole slot, a hook, or any other suitable coupling device. Mount 2104 may be configured to couple housing 2100 to a vertical surface and/or a horizontal surface. For example, mount 2104 may be configured to couple housing 2100 to a mirror, a wall, a counter, or a table.

Housing 2100 may include a cartridge compartment 2105. Cartridge compartment 2105 is configured to receive floss cartridge 2250. Housing 2100 may include at least one cartridge coupling 2115. Cartridge coupling 2115 is configured to facilitate alignment and/or coupling of floss cartridge 2250 to housing 2100. Cartridge coupling 2115 may include one or more clips and/or tabs 2116. Cartridge coupling 2115 may include an alignment post 2117. Cartridge coupling 2115 may include an alignment frame 2118 shaped to receive floss cartridge 2250.

FIG. 3I shows a front view of floss cartridge 2250 and a rear view of housing 2100. Floss cartridge 2250 is configured to be removably coupled to housing 2100. FIGS. 3J-3N show one embodiment of a floss cartridge 2250. FIG. 3J shows a front view of floss cartridge 2250. FIG. 3K shows a front view of floss cartridge 2250 with a front 2253 of cartridge chassis 2251 removed. FIGS. 3L-3N show rear, top, and exploded views, respectively, of floss cartridge 2250. Floss cartridge 2250 is configured to hold and feed floss. Floss cartridge 2250 may be configured to feed floss toward top 2101 and/or front 2102 of housing 2100. Floss cartridge 2250 may be configured to feed floss toward floss exit hole 1311 of housing 2100.

Floss cartridge 2250 may include a cartridge chassis 2251. Cartridge chassis 2251 provides a structure to which components of floss cartridge 2250 may be coupled. Cartridge chassis 2251 may partially or fully enclose one or more components of floss cartridge 2250. Cartridge chassis 2251 may include a top 2252, a front 2253, and a back 2254.

Cartridge chassis 2251 may include one or more coupling features 2255 configured to facilitate coupling floss cartridge 2251 to housing 2100. Coupling features 2255 may include one or more clips and/or tabs 2256 configured to be coupled to clips and/or tabs 2116 of housing 2100. Coupling features 2255 may include an alignment opening 2257 configured to receive alignment post 2117 of housing 2100.

Cartridge chassis 2251 may include grip surfaces 2258 to make it easier for a user to grip floss cartridge 2251. Grip surfaces 2258 may be formed on the sides of cartridge chassis 2251, or any other suitable location. Grip surfaces 2258 may include flattened portions and/or depressions formed in cartridge chassis 2251. Cartridge chassis 2251 may include a transparent portion to provide a visual indicator of how much floss is remaining.

Floss cartridge 2250 may include a feed point 1201. Feed point 1201 is a point from which floss is fed.

Floss cartridge 2250 includes a spool holder 2210 configured to hold a spool S. Spool S may be replaceable. Floss may be fed from spool S by two rollers 1220 which contact each other at a pinch point 1221, in which case feed point 1201 may be pinch point 1221. Alternatively, floss may be pulled from spool S by hand, in which case feed point 1201 may be a point where floss leaves spool S. Floss cartridge 2250 may include a feed sensor 1202 configured to sense when floss has been fed. Feed sensor 1202 may include any one or any combination of a switch, a pressure sensor, a motion sensor, or any other suitable sensor.

Spool holder 2210 may include a spool post 2211 coupled to cartridge chassis 2251. Spool holder 2210 may include a spool compartment 2212 formed in cartridge chassis 2251. Spool compartment 2212 may be used by itself to hold spool S, or in conjunction with a spool post 2211. Spool holder 2210 may orient an axis of rotation of spool S in a horizontal orientation (as shown in FIG. 30), vertical orientation (as shown in FIG. 3P), or other orientation. Spool S may be disc-shaped, cylindrical, conical, or other suitable shape. Spool S may include a portion of floss that is colored differently to provide an indication to replace spool S and/or floss cartridge 2250.

Floss cartridge 2250 may include a pair of rollers 1220. Rollers 1220 may be driven by a motor or by a user. Rollers 1220 may be coupled to cartridge chassis 2251.

Rollers 1220 may contact each other at a pinch point 1221. Rollers 1220 are configured to pull floss from spool holder 2210 and feed floss from pinch point 1221. Rollers 1220 may have a diameter of approximately 5 mm to 15 mm, or approximately 1 mm to 50 mm. Rollers 1220 may have different diameters. Rollers 1220 may rotate at a speed of approximately 400 rpm to 500 rpm, or approximately 10 rpm to 2000 rpm. Pinch point 1221 may be aligned with floss exit hole 1311. Pinch point 1221 may be positioned 5 cm or less from floss exit hole 1311.

One or both rollers 1220 may be at least partially exposed or protrude from cartridge chassis 2251. One or both rollers 1220 may be only partially enclosed by cartridge chassis 2251. Pinch point 1221 may be exposed to an exterior of cartridge chassis 2251. This may allow floss to exit floss cartridge 2250 without having to be aligned with an opening or hole in cartridge chassis 2251.

FIG. 3Q shows another embodiment of a floss cartridge 2250. Floss cartridge 2250 may include only a single roller 1220 coupled to cartridge chassis 2251. The single roller 1220 may be configured to work with another roller 1220 coupled to housing 2100. Roller 1220 of floss cartridge 2250 may be brought into contact with roller 1220 of housing 2100 at a pinch point 1221 when floss cartridge 2250 is coupled to housing 2100.

Floss cartridge 2250 may include one or more feed guides 1222. Feed guides 1222 may be placed before and/or after pinch point 1221 of rollers 1220. Feed guides 1222 may include any one or any combination of tubes, channels, grooves, holes, or any other suitable device. For example, feed guides 1222 may include a guide hole 1223 between spool holder 2210 and pinch point 1221. Feed guides 1222 may be positioned between 1 mm and 50 mm from pinch point 1221. Feed guides 1222 are configured to guide floss through pinch point 1221 of rollers 1220.

FIGS. 3B-3D show various embodiments of rollers 1220 with a spring 1224. FIG. 3B shows roller 1220 with spring 1224 in tension. FIG. 3C shows roller 1220 with spring 1224 in compression. FIG. 3D shows roller 1220 with spring 1224 in torsion. Rollers 1220 may be biased against each other. For example, two rollers 1220 may be biased against each other with a force of approximately 200 grams to 300 grams, or approximately 10 grams to 1000 grams. Rollers 1220 may be biased against each other with spring 1224. Spring 1224 may be in tension, compression, or torsion. Rollers 1220 may be biased against each other with a weight or any other suitable device. One or both rollers 1220 may be mounted on an arm 1225. One or both rollers 1220 may include bearings 1226.

FIGS. 3E-3H show examples of how rollers 1220 may be arranged and/or oriented when floss cartridge 2250 is coupled to housing 2100.

FIGS. 3E-3F shows rollers 1220 arranged with their axes of rotation 1227 parallel to a vertical surface. Rollers 1220 may have axes of rotation 1227 that are horizontal or level. Rollers 1220 may have axes of rotation 1227 that are parallel to each other. Rollers 1220 may have axes of rotation 1227 that are at different heights or levels from each other. One roller 1220 may have an axis of rotation 1227 that is higher than an axis of rotation 1227 of the other roller 1220. By adjusting the heights or positions of rollers 1220 with respect to each other, floss F may be fed at a desired feed angle Θ_{F}. The feed angle Θ_{F} may be a tangent of pinch point 1201. The feed angle Θ_{F} may be between approximately 0 degrees and 90 degrees from vertical, or between approximately 0 degrees and 15 degrees from vertical.

FIGS. 3G-3H shows rollers 1220 arranged with their axes of rotation 1227 at an angle to a horizontal surface. Rollers 1220 may have axes of rotation 1227 that are parallel to each other. By adjusting the angle of rollers 1220 relative to a horizontal surface, floss F may be fed at a desired feed angle Θ_{F}. The angle of rollers 1220 may be between approximately 0 degrees and 90 degrees from horizontal, or between approximately 0 degrees and 15 degrees from horizontal. The feed angle Θ_{F} may be normal to axes of rotation 1227. Feed angle Θ_{F} may be between approximately 0 degrees and 90 degrees from vertical, or between approximately 0 degrees and 15 degrees from vertical.

Referring back to FIGS. 1G-1L, floss dispenser 2000 may include at least one button 1230. Button 1230 may include a mechanical button and/or a touch-sensitive button such as a capacitive switch. Button 1230 may be coupled to housing 2100. Button 1230 may be coupled to front 2102 of housing 2100 and/or any other part of housing 2100. For a front 2102 of housing 2100 that is round or circular, first button 1231 and second button 1232 may be formed as two halves of a circle or a disc, and form at least a portion of front 2102 of housing 2100. Multiple buttons 1230 may be labeled to correspond to different users. For example, a first button 1231 may correspond to a first user, and a second button 1232 may correspond to a second user.

Button 1230 is configured to cause floss to be fed from spool holder 2210. Button 1230 may be configured to cause floss to be fed either through a user-powered mechanism or an electrically-powered mechanism. Alternatively, in addition to or in place of button 1230, floss dispenser 2000 may include any one or any combination of a motion sensor, a microphone configured to receive a voice and/or sound command, a lever, a crank, a knob, or any other suitable controls or devices for feeding floss. Alternatively, floss dispenser 2000 may include no buttons or mechanisms, and floss is fed by pulling floss from spool holder 2210 by hand.

Floss dispenser 2000 may include a motor 1240. Motor 1240 may be connected to a motor controller 1630. Motor 1240 may include any one or any combination of a DC motor, an AC motor, a stepper motor, or any other suitable actuator. Motor 1240 may be coupled to housing 2100. Alternatively, motor 1240 may be a part of floss cartridge 2250 and coupled to cartridge chassis 2251. Motor 1240 may become coupled to one or both rollers 1220 when floss cartridge 2250 is coupled to housing 2100. Motor 1240 is configured to rotate rollers 1220. Motor 1240 may be configured to rotate rollers 1220 with sufficient speed to feed 18 inches of floss in approximately 0.1 seconds to 10 seconds, or approximately 3 seconds or less. Motor 1240 may have a speed of approximately 10 rpm to 20000 rpm.

Floss dispenser 2000 may include gearing 1241. Gearing 1241 may couple motor 1240 to one or both rollers 1220. At least a portion of gearing 1241 may be coupled to housing 2100. At least a portion of gearing 1241 may be a part of floss cartridge 2250 and coupled to cartridge chassis 2251. Gearing 1241 may be configured to gear down an output from motor 1240 to obtain a desired speed and/or torque at rollers 1220. Gearing 1241 may include any one or any combination of a spur gear, a worm gear, a belt, or any other gearing.

FIGS. 2A-2C show enlarged views of spout 1300 and cutter 1400. FIG. 2A shows an enlarged front view of one embodiment of spout 1300 and cutter 1400. FIGS. 2B-2C show enlarged front views of two embodiments of guide walls 1314 and cutter 1400.

Spout 1300 is formed in housing 2100. Spout 1300 may include an opening formed through a wall of housing 2100. Spout 1300 may be elongate or any other suitable shape. Spout 1300 may be at least partially formed in top 2101 and/or front 2102 of housing 2100. Spout 1300 may be vertical. Spout 1300 may extend from top 2101 of housing 2100 to front 2102 of housing 2100 and at least partially down front 2102 of housing 2100. Alternatively, spout 1300 may be formed in any other part of housing 2100. Spout 1300 is configured to guide to cutter 1400 floss fed from floss cartridge 2250.

Spout 1300 may include a floss exit hole 1311. Floss exit hole 1311 may be round, elongate, or any other suitable shape. Floss exit hole 1311 may include at least a portion having a width of approximately 2 mm to 8 mm. Floss exit hole 1311 may be formed with or discrete from spout 1300. Floss exit hole 1311 is configured to allow floss to exit housing 2100.

Spout 1300 includes a cutter entry 1312 and a cutter exit 1313. Cutter entry 1312 may be positioned above cutter exit 1313. Cutter entry 1312 may include guide walls 1314. At least a portion of guide walls 1314 may be any one or any combination of parallel, V shaped, or any other suitable shape. Guide walls 1314 may be configured to reduce the likelihood that floss will miss or bypass cutter 1400. Guide walls 1314 may include a guard 1315 configured to reduce the likelihood that floss will miss or bypass cutter 1400.

Cutter 1400 may be coupled to housing 2100. Alternatively, at least a portion of cutter 1400 may be a part of floss cartridge 2250 and coupled to cartridge chassis 2251. Cutter 1400 may be coupled between cutter entry 1312 and cutter exit 1313. Cutter 1400 may include a stamped floss cutter. Cutter 1400 may include a blade and/or other suitable cutting device. Cutter 1400 may be manual or powered. Cutter 1400 is configured to cut floss. Cutter 1400 may include a cutter sensor 1402 configured to sense when cutter 1400 has cut floss. Cutter sensor 1402 may include any one or any combination of a switch, a pressure sensor, a motion sensor, or any other suitable sensor.

Spout 1300 may be configured so that floss fed from feed point 1201 will be guided into cutter entry 1312. Spout 1300 may be configured so that floss fed from feed point 1201 may be draped over cutter 1400. For example, spout 1300 may be positioned so that when a length of floss is fed, floss will fall under its own weight into cutter entry 1312 and drape over cutter 1400. As another example, spout 1300 may be positioned so that when a length of floss is fed, spout 1300 will be positioned under at least a portion of the length of floss. As yet another example, spout 1300 may extend from floss exit hole 1311 to cutter entry 1312 so that a length of floss may be pulled by a user from floss exit hole 1311 to cutter entry 1312. Floss may be draped over cutter 1400 by pulling floss from cutter entry 1312 towards cutter exit 1313. Floss may be cut by pulling floss into cutter 1400.

Spout 1300 and/or cutter 1400 may be configured to reduce the likelihood of injury to a user. For example, spout 1300 may be sufficiently narrow to prevent the entry of a finger or other body part. As another example, cutter 1400 may be arranged with a sharp or cutting surface out of reach of a finger or other body part.

FIG. 2D shows an enlarged cross-sectional side view of cutter 1400. Floss F may be fed from feed point 1201 in an upward direction, so that floss F may fall under its own weight. For example, floss F may be fed at a feed angle Θ_{F} of approximately 10 degrees from vertical, or between approximately 0 degrees and 90 degrees from vertical.

Cutter 1400 may be positioned relative to floss F so that it is capable of cutting floss. For example, cutter 1400 may be positioned with a longitudinal axis 1401 at a cutter angle Θ_{C} of approximately 45 degrees to 135 degrees from horizontal.

Cutter 1400 may be positioned higher than feed point 1201. Floss F may have sufficient stiffness to be fed above cutter 1400, before falling under its own weight. This allows a length of floss F to be draped over cutter 1400, and may facilitate the cutting of floss when floss F is pulled downward.

FIG. 7A shows one embodiment of cutter 1400. Cutter 1400 may include a base 1403 and a tongue 1404. Tongue 1404 may be coupled to base 1403 to form a notch 1405 between tongue 1404 and base 1403. Tongue 1404 may have a sharpened edge 1406 configured to cut floss pulled into notch 1405. Notch 1405 may have an entrance 1407.

FIG. 7B shows cutter 1400 with one embodiment of a clearing device 1410. A cut end of a spool of floss may become stuck in notch 1405 when floss is pulled into notch 1405 and cut by cutter 1400. Clearing device 1410 is configured to release the end stuck in notch 1405. Clearing device 1410 releases the end from notch 1405 so that another length of floss may be fed from the spool without the end being stuck in notch 1405.

Clearing device 1410 may include a clearing wire 1411. Clearing wire 1411 may be coupled across an entrance 1407 of notch 1405. Clearing wire 1411 may be fixed at one or both ends. Clearing wire 1411 may be made of a springy or resilient material. Clearing wire 1411 may be made of a metal, plastic, wood, or other suitable material. Clearing wire 1411 may be configured to bow or flex when floss is pulled into notch 1405. Clearing wire 1411 may be configured to unbow or unflex and push or urge out an end of a spool of floss stuck in notch 1405 after the floss is cut by cutter 1400.

FIGS. 8A-8F show one embodiment of a method of using cutter 1400 with a clearing wire 1411. FIGS. 8A and 8D show side and back views of clearing wire 1411 in an unbowed or unflexed state. FIGS. 8B and 8E show side and back views of clearing wire 1411 in a bowed or flexed state. Clearing wire 1411 is bowed or flexed by floss F when floss F is pulled into notch 1405. When floss F is cut, an end E of floss F may be stuck in notch 1405. FIGS. 8C and 8F show side and back views of clearing wire 1411 returned to the unbowed or unflexed state. After floss F is cut, clearing wire 1411 is free to unbow or unflex and pushes or urges end E of floss F out of notch 1405.

FIGS. 9A-9D show cutter 1400 with other embodiments of a clearing device 1410.

FIG. 9A shows a clearing device 1410 including rollers 1220 capable of reversing a direction of rotation. Rollers 1220 may be driven in a reverse direction to pull floss F out of notch 1405.

FIG. 9B shows a clearing device 1410 including a clearing spring 1412. Clearing spring 1412 may be coupled to cutter 1400. Clearing spring 1412 compresses when floss F is pulled into notch 1405. When clearing spring 1412 uncompresses, floss F may be released from notch 1405.

FIG. 9C shows a clearing device 1410 including a clearing motor 1413. Clearing motor 1413 may be coupled to cutter 1400. Clearing motor 1413 is configured to rotate cutter 1400. Clearing motor 1413 may be configured to rotate cutter 1400. Clearing motor 1413 may rotate cutter 1400 toward feed point 1201 to release floss F from notch 1405. Clearing motor 1413 may be configured to rotate cutter 1400 in either direction. Clearing motor 1413 may rotate cutter 1400 360 degrees or more. Alternatively, clearing device 1410 may include a torsion spring or other device configured to rotate cutter 1400.

FIG. 9D shows a clearing device 1410 including a clearing blower 1414. Clearing blower 1414 may be positioned to blow a gas at floss F to push floss F out of notch 1405.

Referring back to FIGS. 1G-1L, floss dispenser 2000 may include a display 1500. Display 1500 may include a spout display 1510. Spout display 1510 may include an LCD display and/or any other suitable display.

Spout display 1510 is configured to indicate floss is ready to be cut. Spout display 1510 may indicate for a predetermined period of time, or until the floss has been cut. For example, spout display 1510 may indicate for approximately 3 seconds to 10 seconds after floss has been fed to spout 1300. Spout display 1510 may indicate by any one or any combination of turning on continuously, flashing, “breathing,” pulsating, indicating a direction to pull the floss in order to cut the floss, or any other suitable manner.

Spout display 1510 may include one or more spout lights 1511. Spout lights 1511 may include LEDs and/or any other suitable lights. For example, spout lights 1511 may include three LEDs, or one to 10 LEDs. Spout lights 1511 may be configured to display different colors. For example, spout lights 1511 may include RGB LEDs and/or LEDs of different colors. Spout lights 1511 may be coupled to one or more edges and/or guide walls 1314 of spout 1300. Spout lights 1511 may light progressively or in a wave from cutter entry 1312 to cutter exit 1313 to indicate a direction in which floss should be pulled.

Display 1500 may include a reminder display 1520. Reminder display 1520 may include an LCD display and/or any other suitable display. Spout display 1510 and reminder display 1520 may be the same or different displays.

Reminder display 1520 is configured to display reminders to floss. Reminder display 1520 may display a reminder to floss after a predetermined period of time has passed. Reminder display 1520 may display a reminder to floss after a predetermined period of time has passed since a last flossing. For example, reminder display 1520 may display a reminder approximately 22 hours after floss was last fed, or approximately 20 hours after the last reminder if no floss was fed during the last reminder. Reminder display 1520 may display a reminder for a predetermined period of time, or until the floss has been cut. For example, reminder display 1520 may display a reminder for approximately 4 hours. Reminder display 1520 may display a reminder by any one or any combination of turning on continuously, flashing, “breathing,” pulsating, or any other suitable manner. Reminder display 1520 may be configured to display reminders to multiple users. For example, reminder display 1520 may indicate for which particular user a reminder is intended. Reminder display 1520 may be configured to display a reminder only when a user is detected in a vicinity of floss dispenser 2000. For example, any one or any combination of a motion sensor, light sensor, or microphone may be used to detect a user in the vicinity of floss dispenser 2000.

Reminder display 1520 may be configured to display a graphical or symbolic representation. For example, reminder display 1520 may be configured to display a reward such as a smile after a user has flossed. As another example, reminder display 1520 may be configured to display a frown as a reminder to floss.

Reminder display 1520 may be configured to indicate a portion of a mouth to be flossed, such as a quadrant of the mouth to be flossed. Reminder display 1520 may be configured to indicate different portions of a mouth to be flossed in sequence, each for a predetermined period of time. For example, reminder display 1520 may be configured to indicate an upper left quadrant, a lower left quadrant, a lower right quadrant, and an upper right quadrant, each for approximately 30 seconds.

Reminder display 1520 may be configured to provide a timer to display a recommended amount of flossing time. Reminder display 1520 may be configured to provide a timer after floss has been fed. Reminder display 1520 may be configured to display an elapsed time and/or a remaining time. For example, reminder display 1520 may be configured to display a recommended flossing time of approximately 2 minutes, which starts counting down after button 1230 is operated. Reminder display 1520 may be configured to display time elapsed since last flossing and/or time remaining until next recommended flossing. Reminder display 1520 may be configured to display the time of last flossing and/or the time of next recommended flossing.

Reminder display 1520 may include one or more reminder lights 1521. Reminder lights 1521 may include LEDs and/or any other suitable lights. For example, reminder lights 1521 may include 12 LEDs, or one to 50 LEDs. Reminder lights 1521 may be coupled to front 2102 of housing 2100 in a circle. Reminder lights 1521 may be coupled to housing 2100 in a square or any other arrangement. Reminder lights 1521 may be coupled along a perimeter of front 2102 of housing 2100. Reminder lights 1521 may be coupled to any other part of housing 2100.

Reminder lights 1521 may be arranged to display a graphical or symbolic representation. For example, reminder lights 1521 may be arranged in a curve that resembles a smile. For a front 2102 of housing 2100 that is circular, reminder lights 1521 may be arranged along a perimeter of a lower half of front 2102 of housing 2100 to resemble a smile. One or more reminder lights 1521 in a smile may be lit more brightly than other reminder lights 1521 in the smile to resemble a “sparkle” in the smile. As another example, reminder lights 1521 may be arranged in a curve that resembles a frown. For a front 2102 of housing 2100 that is circular, reminder lights 1521 may be arranged along a perimeter of an upper half of front 2102 of housing 2100 to resemble a frown. Reminder lights 1521 may be configured to display different colors. For example, reminder lights 1521 may include RGB LEDs and/or LEDs of different colors.

Reminder lights 1521 may be configured to display reminders for multiple users. For example, multiple reminder lights 1521 may be labeled to correspond to different users. As another example, multiple reminder lights 1521 coupled to different parts of housing 2100 may correspond to different users.

Reminder lights 1521 may be configured to indicate a portion of a mouth to be flossed. For example, reminder lights 1521 may be configured to indicate a quadrant of the mouth to be flossed. Reminder lights 1521 may be configured to indicate different portions of a mouth to be flossed in sequence, each for a predetermined period of time. For example, reminder lights 1521 in an upper left quarter of front 2102 of housing 2100 may be used to indicate that an upper left quadrant of the mouth is to be flossed, then reminder lights 1521 in a lower left quarter of front 2102 of housing 2100 may be used to indicate that a lower left quadrant of the mouth is to be flossed, and so on, each quadrant for approximately 30 seconds, for a total of approximately 2 minutes for the entire mouth.

Reminder lights 1521 may be configured to display a recommended amount of flossing time. Reminder lights 1521 may be arranged in a circle or other shape that resembles a face of a clock. Reminder lights 1521 may be configured to display an elapsed flossing time and/or a remaining flossing time. For example, reminder lights 1521 may be configured to display a remaining flossing time of approximately 2 minutes which starts counting down after floss has been dispensed. Reminder lights 1521 may be controlled to resemble a timer counting up or down. For example, all reminder lights 1521 may be turned on, and then turned off one at a time over a period of approximately 2 minutes in a countdown or racetrack fashion, after which all reminder lights 1521 are off. Reminder lights 1521 may be configured to display time elapsed since last flossing and/or time remaining until next flossing.

Floss dispenser 2000 may include electronics 1600. Electronics 1600 may be coupled to housing 2100. Alternatively, at least a portion of electronics 1600 may be a part of floss cartridge 2250 and coupled to cartridge chassis 2251.

Electronics 1600 may include a timer 1610. Timer 1610 may be coupled to any one or any combination of feed sensor 1202, cutter sensor 1402, or button 1230. Timer 1610 may be configured to determine whether a predetermined period of time has passed since an event. For example, timer 1610 may be configured to determine whether a predetermined period of time has passed since floss was last dispensed and/or since a user last flossed. Timer 1610 may be configured to provide an amount of flossing time.

Timer 1610 may be configured to give visual and/or audio indications. Timer 1610 may be connected to reminder display 1520 and/or reminder lights 1521 to give visual indications. Timer 1610 may be connected to a buzzer or speaker 1611 to give audio indications.

Electronics 1600 may include a display controller 1620. Display controller 1620 is configured to control display 1500. Display controller 1620 may be configured to control spout lights 1511 and/or reminder lights 1521.

Electronics 1600 may include a motor controller 1630. Motor controller 1630 is configured to control motor 1240. Motor controller 1630 may be configured to provide power to motor 1240. Motor controller 1630 may be configured to turn on motor 1240 for a desired period of time. Alternatively, motor controller 1630 may be configured to turn on motor 1240 for as long as button 1230 is operated. Motor controller 1630 may be configured to control a speed of motor 1240. Motor controller 1630 may be configurable to adjust a length of floss fed. For example, motor controller 1630 may be configured to feed approximately 18 inches, or approximately 10 inches to 30 inches of floss.

Electronics 1600 may include a power source 1640. Power source 1640 is configurable to provide power to one or more components of electronics 1600. Power source 1640 may include any one or any combination of a battery, an AC adapter, a solar cell, or any other suitable power source. Power source 1640 may include a power switch 1641. Power switch 1641 is configurable to turn power source 1640 on and off. Power source 1640 may include a power level indicator configured to indicate how much power is remaining. At least a portion of a power source 1640, such as a battery or solar cell, may be a part of floss cartridge 2250 and coupled to cartridge chassis 2251.

Electronics 1600 may include a user selector switch 1650. User selector switch 1650 may allow floss dispenser 2000 to be configurable for use with a single user or two or more users. Power switch 1641 and user selector switch 1650 may be the same switch or different switches.

Electronics 1600 may include a printed circuit board (PCB) 1601. Any one or any combination of timer 1610, display controller 1620, motor controller 1630, power source 1640, or user selector switch 1650 may be connected to PCB 1601. Any one or any combination of timer 1610, display controller 1620, or motor controller 1630 may be implemented in one or more integrated chips 1602.

Housing 2100 may include a light ring 1107 and/or a light reflector 2108.

FIG. 4A shows one embodiment of light ring 1107. Light ring 1107 may be coupled to front 2102 of housing 2100. Light ring 1107 may be coupled to a perimeter of front 2102 of housing 2100. Light ring 1107 may be coupled to any other part of housing 2100. Light ring 1107 may be circular. Light ring 1107 may be square or any other shape. One or more spout lights 1511 and/or one or more reminder lights 1521 may be arranged in a vicinity of light ring 1107. For example, one or more spout lights 1511 and/or one or more reminder lights 1521 may be positioned approximately 0.1 mm to 10 mm from light ring 1107. Light ring 1107 may be at least partially made of a semi-transparent and/or diffusive material. For example, light ring 1107 may be made of a semi-opaque plastic. Light ring 1107 is configured to diffuse light from one or more spout lights 1511 and/or one or more reminder lights 1521. Light ring 1107 may cause light from spout lights 1511 and/or reminder lights 1521 to be emitted more uniformly along light ring 1107. Light ring 1107 may increase an amount of light from spout lights 1511 and/or reminder lights 1521 that is emitted from housing 2100.

FIG. 4C shows one embodiment of light reflector 2108. Light reflector 2108 may be coupled to front 2102 of housing 2100. Light reflector 2108 may be coupled to a perimeter of front 2102 of housing 2100. Light reflector 2108 may be arranged next to light ring 1107. Light reflector 2108 may be coupled to any other part of housing 2100. One or more spout lights 1511 and/or one or more reminder lights 1521 may be arranged in a vicinity of light reflector 2108. For example, one or more spout lights 1511 and/or one or more reminder lights 1521 may be positioned approximately 0.1 mm to 10 mm from light reflector 2108. Light reflector 2108 may be at least partially made of a reflective material. Light reflector 2108 may include white and/or light-colored walls. Light reflector 2108 may include parabolic and/or hyperbolic walls. Light reflector 2108 may increase an amount of light from spout lights 1511 and/or reminder lights 1521 that is emitted from housing 2100.

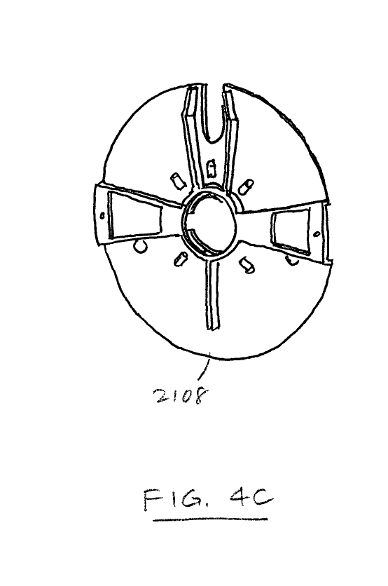

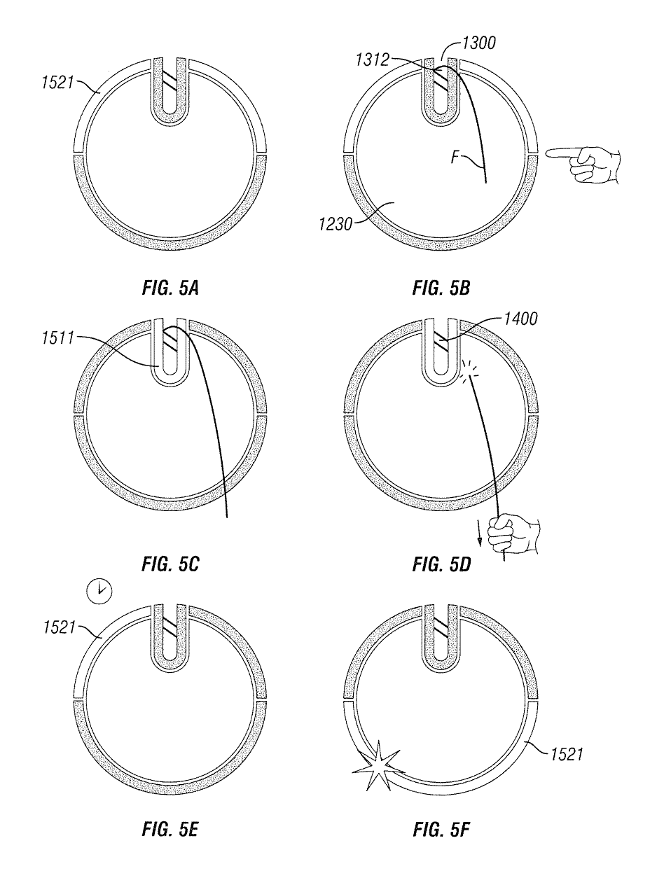

FIGS. 5A-5F show one embodiment of a method of using floss dispenser 1000 in single user mode. Although the method shown is for floss dispenser 1000, the method may also be used for floss dispenser 2000.

FIG. 5A shows a reminder to floss. Reminder lights 1521 in an upper half of front 1102 of housing 1100 display a red frown. Speaker 1611 may give an audio reminder.

FIG. 5B shows feeding floss F to spout 1300. Floss F is fed to spout 1300 by pressing button 1230. Floss F may fall into cutter entry 1312.

FIG. 5C shows an indication that floss F is ready to be cut. After floss F is fed to spout 1300, spout lights 1511 along edges of spout 1300 indicate that floss is ready to be cut.

FIG. 5D shows cutting floss F. Floss F is cut by pulling floss F into cutter 1400. Floss F may be cut by pulling floss downward.

FIG. 5E shows an indication of a portion of a mouth to be flossed. Reminder lights 1521 in an upper left quarter of front 1102 of housing 1100 indicate that an upper left quadrant of the mouth is to be flossed. Then reminder lights 1521 in a lower left quarter of front 1102 of housing 1100 may indicate that a lower left quadrant of the mouth is to be flossed, and so on. Each quadrant is indicated for approximately 30 seconds, for a total of approximately 2 minutes for the entire mouth. Speaker 1611 may give audio instructions and/or play music.

FIG. 5F shows an indication that a recommended amount of flossing time has elapsed. Reminder lights 1521 in a lower half of front 1102 of housing 1100 display a white smile. One or more reminder lights 1521 in a smile is lit more brightly than other reminder lights 1521 in the smile to resemble a “sparkle” in the smile. Speaker 1611 may play a completion melody. Reminder lights 1521 then turn off until the next reminder.

FIGS. 6A-6F show another embodiment of a method for using floss dispenser 1000 in dual user mode. Although the method shown is for floss dispenser 1000, the method may also be used for floss dispenser 2000.

FIG. 6A shows a reminder to floss for a first user. Reminder lights 1521 along an upper left quarter of front 1102 of housing 1100 display half of a red frown. Speaker 1611 may give an audio reminder. Reminder lights 1521 along an upper right quarter of front 1102 of housing 1100 may be used to display reminders for a second user.

FIG. 6B shows feeding floss F to spout 1300. Floss F is fed to spout 1300 by pressing first button 1231. Floss F may fall into cutter entry 1312. Second button 1232 may be used for a second user.

FIG. 6C shows an indication that floss F is ready to be cut. After floss F is fed to spout 1300, spout lights 1511 along edges of spout 1300 indicate that floss F is ready to be cut.

FIG. 6D shows cutting floss F. Floss F is cut by pulling floss into cutter 1400. Floss may be cut by pulling floss downward.

FIG. 6E shows an indication of a portion of a mouth to be flossed. Reminder lights 1521 in an upper left portion of front 1102 of housing 1100 indicate that an upper left quadrant of the mouth is to be flossed. Then reminder lights 1521 in a lower left portion of front 1102 of housing 1100 may indicate that a lower left quadrant of the mouth is to be flossed, and so on. Each quadrant is indicated for approximately 30 seconds, for a total of approximately 2 minutes for the entire mouth. Speaker 1611 may give audio instructions and/or play music.

FIG. 6F shows an indication that a recommended amount of flossing time has elapsed. Reminder lights 1521 in a lower half of front 1102 of housing 1100 display a white smile. One or more reminder lights 1521 in a smile may be lit more brightly than other reminder lights 1521 in the smile to resemble a “sparkle” in the smile. Speaker 1611 may play a completion melody. Reminder lights 1521 then turn off until the next reminder.

Floss dispensers 1000 and 2000 may be configured to record, store, and transmit data related to a user's flossing/brushing frequency, time spent in the shower, duration of faucet usage, number of times the toilet is flush, and general water usage. This may be done either via the cloud, by direct electronic connection of said processes to floss dispensers 1000 and 2000, or by the use of radar and/or IR signaling to detect such actions. For example, running water in a shower exhibits a very distinct series of sounds that may be picked up by a microphone. Floss dispensers 1000 and 2000 may use this microphone to record how long a user showers every day; the same can be done for the number of times a person flushes the toilet or how long he/she keeps the faucet on.

Another set of functionalities that may be incorporated into the device is related to the analysis and monitoring of the user's oral and general health. For instance, floss dispensers 1000 and 2000 may contain a cavity that captures a user's breath and analyzes it to detect bad breath or to assess oral microbiome health. Floss dispensers 1000 and 2000 may also contain a built-in optical system that measures the “whiteness” of a user's teeth using reflectance spectroscopy. Additionally, physiological measurements such as electrocardiogram (EKG), heart rate, pulse oximetry (blood oxygenation), pH levels, and sugar levels may also be measured by incorporating the proper electrodes, optics, and/or chemistry. Floss dispensers 1000 and 2000 may provide entertainment to a user. Videos, music and radio may be added to floss dispensers 1000 and 2000.

Floss dispensers 1000 and 2000 may have the capability to be connected to the cloud and/or the web via Wi-Fi, Bluetooth, or other means of connectivity. This connectivity may then allow floss dispensers 1000 and 2000 to send collected data, be it flossing duration, water usage, or the user's physiology, to people and systems of interest. For instance, floss dispensers 1000 and 2000 may send a monthly report to a user's phone, computer, or email detailing the average shower time, the total water use, the number of times the user flossed, or his/her day-to-day sugar levels. In addition, data may also be sent to a user's dentist, doctor, and/or insurance company for both health and logistical purposes. Data connectivity may further allow for cloud-based interactions such as ordering medications, floss refills, toothbrushes, or other products.

While the foregoing has been with reference to particular embodiments of the invention, it will be appreciated by those skilled in the art that changes in these embodiments may be made without departing from the principles and spirit of the invention.

1. A floss cartridge comprising:
a cartridge chassis configured to hold floss; and
a pair of rollers coupled to the cartridge chassis, the rollers contacting each other at a pinch point, the rollers configured to feed the floss through the pinch point at a feed angle.

2. The floss cartridge of claim 1, wherein the cartridge chassis is configured to be coupled to a housing of a floss dispenser.

3. The floss cartridge of claim 1, wherein the rollers are configured to feed the floss toward a top of the cartridge chassis.

4. The floss cartridge of claim 1, wherein the rollers are configured to feed the floss toward a front of the cartridge chassis.

5. The floss cartridge of claim 1, wherein axes of rotation of the rollers are horizontal.

6. The floss cartridge of claim 1, wherein the axes of rotation of the rollers are at different heights.

7. The floss cartridge of claim 1, wherein the feed angle is a tangent of the pinch point.

8. The floss cartridge of claim 1, wherein the feed angle is between 0 degrees and 90 degrees from vertical.

9. The floss cartridge of claim 1, wherein the feed angle is between 0 degrees and 15 degrees from vertical.

10. The floss cartridge of claim 1, wherein axes of rotation of the rollers are between 0 degrees and 90 degrees from horizontal.

11. The floss cartridge of claim 1, wherein axes of rotation of the rollers are between 0 degrees and 15 degrees from horizontal.

12. The floss cartridge of claim 1, wherein the feed angle is normal to axes of rotation of the rollers.

13. The floss cartridge of claim 1, wherein the rollers are biased against each other.

14. The floss cartridge of claim 1, further comprising:
a feed guide coupled to the cartridge chassis, the feed guide configured to guide the floss through the pinch point.

15. The floss cartridge of claim 14, further comprising:
a spool holder coupled to the cartridge chassis, the spool holder configured to hold a spool of floss.

16. The floss cartridge of claim 15, wherein the feed guide is positioned between the spool holder and the pinch point.

17. A floss cartridge comprising:
a cartridge chassis configured to hold floss; and
means for feeding the floss at a feed angle, the means for feeding the floss coupled to the cartridge chassis.

18. The floss cartridge of claim 17, wherein the feed angle is between 0 degrees and 90 degrees from vertical.

19. A method for using a floss dispenser, the method comprising:
coupling a floss cartridge to a housing, the floss cartridge configured to hold floss, the floss cartridge having a pair of rollers contacting each other at a pinch point; and
driving a pair of rollers to feed the floss from the pinch point at a feed angle.

20. The method of claim 19, wherein the feed angle is between 0 degrees and 90 degrees from vertical.

21-32. (canceled)
